(19) United States
(12) Patent Application Publication
(10) Pub. No.: US 2022/0009086 A1
(43) Pub. Date: Jan. 13, 2022

(54) STICK DEVICE AND USER INTERFACE

(71) Applicant: PRAMOD KUMAR VERMA, CALABASAS, CA (US)

(72) Inventor: PRAMOD KUMAR VERMA, CALABASAS, CA (US)

(21) Appl. No.: 17/311,994

(22) PCT Filed: Dec. 9, 2019
(86) PCT No.: PCT/US2019/065264

§ 371 Date: Jun. 8, 2021

Related U.S. Application Data
(60) Provisional application No. 62/777,208, filed on Dec. 9, 2018.

(51) Int. Cl. B25J 9/08; B25J 9/16; G06F 3/01; G06F 3/16

(52) U.S. Cl. CPC B25J 9/08; B25J 9/1615; G06F 3/017; B25J 9/1694; B25J 9/1689; B25J 9/1661; G06F 3/167

(57) ABSTRACT

This invention introduces a mobile robotic arm equipped with a projector camera system, and computing device connected with interne and sensors, which can stick to any nearby surface using a sticking mechanism. Projector camera system displays the user interface on the surface. Users can interact with the device using the user interface using voice, body gestures, remote device, wearable or handheld device. We call this device “Stick Device” or “Stick User Interface”. In addition, the device can execute application specific tasks using reconfigurable tools and devices. With these functionalities, the device can be used for various human-computer interaction or human-machine interaction applications.

### CROSS REFERENCE TO RELATED APPLICATIONS

This application claims benefit of priority from PCT/US2019/065264, filed Dec. 9, 2019, entitled “STICK DEVICE AND USER INTERFACE”, which further claims priority from U.S. Provisional Patent Application No. 62/777,208, filed Dec. 9, 2018, entitled “STICK DEVICE AND USER INTERFACE”, which is incorporated herein by reference.

### FIELD OF THE INVENTION

Mobile User-Interface, Human-Computer Interaction, Human-Robot Interaction, Human-Machine Interaction, Computer-Supported Cooperative Work, Computer Graphics, Robotics, Computer Vision, Artificial Intelligence, Personnel Agents or Robots, Gesture Interface, Natural User-Interface.

### INTRODUCTION

Projector-camera systems can be classified into many categories based on design, mobility, and interaction techniques. These systems can be used for various Human-Computer Interaction (HCI) applications.

The despite the usefulness of existing projector camera systems, they are mostly popular in academic and research environments rather than among the general public. We believe the problem is in their design. They must be simple, portable, multi-purpose, and affordable. They must have various useful apps and app-stores like Ecosystem. Our design goal was to invent a novel and projector-camera device to satisfy all the following design constraints described in the next section.

One of the goals of this project was to avoid manual setup of a projector-camera system using additional hardware such as tripod, stand or permanent installation. The user should be able to set up the system quickly. The system should be able to deploy in any 3D configuration space. In this way a single device can be used for multiple projector-camera applications at different places.

The system should be portable and mobile. The system should be simple and able to fold. The system should be modular and should be able to add more application specific components or modules.

The system should produce a usable, smart or intelligent user interface using state of the art Artificial Intelligence, Robotic, Machine Learning, Natural Language Processing, Computer Vision and Image processing techniques such as gesture recognition, speech-recognition or voice-based interaction, etc. The system should be assistive, like Siri or similar virtual agents.

The system should be able to provide an App Store, Software Development Kit (SDK) platform, and Application Programming Interface (API) for developers for new projector-camera apps. Instead of wasting time and energy in installation, setup and configuration of hardware and software, researchers and developers can easily start developing the apps. It can be used for non-projector applications such as sensor, light, or even robotic arm for manipulating objects.

### RELATED WORK

One of the closely related systems is a “Flying User Interface” (U.S. Pat. No. 9,720,519B2) in which a drone sticks to and augments a user interface on surfaces. Drone based systems provide high mobility and autonomous deployment, but currently they make lots of noise. Thus, we believe that same robotic arm with sticking ability that can be used without a drone for projector-camera applications. System also becomes cheaper and highly portable. Other related work and systems are described in next subsections.

Traditional Projector-Camera systems need manual hardware and software setup for projector-camera applications such as PlayAnywhere (Andrew D. Wilson. 2005. PlayAnywhere: a compact interactive tabletop projection-vision system.), Digital Desk (Pierre Wellner. 1993. Interacting with paper on the DigitalDesk), etc. They can be used for Spatial Augmented Reality for mixing real and virtual worlds.

Wearable Projector-Camera system users can wear or hold a projector-camera system and interact with gestures. For example, Sixth-Sense (U.S. Pat. No. 9,569,001B2) and OmiTouch (Chris Harrison, Hrvoje Benko, and Andrew D. Wilson. 2011. OmniTouch: wearable multitouch interaction everywhere.).

Some of the examples are Mobile Projector projector-camera based smart-phones such as Samsung Galaxy Beam, an Android smartphone with a built-in projector. Another related system in this category is the Light Touch portable projector-camera system introduced by Light Blue Optics. Mobile projector-camera systems can also support multi-user interaction and can be environment aware for pervasive computing spaces. Systems such as Mobile Surface projects user-interface on any free surface and enables interaction in the air.

Mobility can be achieved using autonomous Aerial Projector-Camera Systems. For example, Displaydrone (Jürgen Scheible, Achim Hoth, Julian Saal, and Haifeng Su. 2013. Displaydrone: a flying robot based interactive display) is a projector-equipped drone or multicopper (flying robot) that projects information on walls, surfaces, and objects in physical space.

Robotic Projector-Camera System category projection can be steered using a robotic arm or device System. For example, Beamatron uses a steerable projector camera-system to project the user-interface in a desired 3D pose. Projector-Camera can be fitted on robotic an arm. LUMINAR lamp (Natan Linder and Pattie Maes. 2010. LuminAR: portable robotic augmented reality interface design and prototype. In Adjunct proceedings of the 23nd annual ACM symposium on User interface software and technology) system, which consist of a robotic arm and a projector camera system designed to augment and steer projection on a table surface. Some mobile robots such as “Keecker” project information on the walls while navigating around the home like a robotic vacuum cleaner.

Personal assistants and device like Siri, Alexa, Facebook portal and similar virtual agents fall in this category. These systems take input from users in the form of voice and gesture, and provide assistance using Artificial Intelligence techniques.

In shorts, we all use computing devices and tools in real life. One problem with these normal devices is we have to hold or grab them during the operation or place them on some surface such as floor, table, etc. Sometimes we have to manually permanently attach or mount them on surfaces such as walls, etc. Because of this problem, handheld devices can only be accessed with a limited configuration in 3D space.

### SUMMARY OF THE INVENTION

To address the above problem, this patent introduces a mobile robotic arm equipped with a projector camera system, computing device connected with internet and sensors, and gripping or sticking interface which can stick to any nearby surface using a sticking mechanism. Projector camera system displays the user interface on the surface. Users can interact with the device using user-interface such as voice, remote device, wearable or handheld device, projector-camera system, commands, and body gestures. For example, users can interact with feet, fingers, or hands, etc. We call this special type of device or machine by “Stick User Interface” or “Stick Device”.

The computing device further consists of other required devices such as accelerometer, gyroscope, compass, flashlight, microphone, speaker, etc. Robotic arm unfolds to a nearby surface and autonomously finds a right place to stick to any surface such as a wall, ceilings, etc. After successful sticking mechanism, device stops all its motors (actuators), augment user interface and perform application specific task.

This system has its own unique and interesting applications by extending the power of the existing available tools and devices. It can expand from fold state and attach to any remote surface autonomously. Because it has onboard computer, it can perform any complex task algorithmically using user-defined software. For example, device may stick to any nearby surface and augments user interface application to assist user to learn dancing, games, music, cooking, navigation, etc. It can be used to display a sign board to the wall for the purpose of advertisement. In another example, we can deploy these devices in a jungle or garden where these devices can hook or stick to rock or tree trunk to provide navigation.

The device can be used with other devices or machines to solve other complex problem. For example, multiple devices can be used to create a large display or panoramic view. System may contain additional application specific device interfaces for the tools and devices. Users can change and configure these tools according to the application logic.

In next sections, drawings and detailed description of the invention will disclose some of the useful and interesting applications of this invention.

### BRIEF DESCRIPTION OF THE DRAWINGS

FIG. 1 is a high-level block diagram of the stick user interface device.

FIG. 2 is a high-level block diagram of the computer system.

FIG. 3 is a high-level block diagram of the user interface system.

FIG. 4 is a high-level block diagram of the gripping or sticking system.

FIG. 5 is a high-level block diagram of the robotic arm system.

FIG. 6 is a detailed high-level block diagram of the application system.

FIG. 7 is a detailed high-level block diagram of the stick user interface device.

FIG. 8 shows a preferred embodiment of a stick user interface device with a robotic arm, projector camera system, computer system, gripping system, and other components.

FIG. 9 shows another configuration of a stick user interface device.

FIG. 10 shows another embodiment of a stick user interface device with two robotic arms, projector camera system, computer system, gripping system, and other components.

FIG. 11 shows another embodiment of a stick user interface device with a robotic arm, projector camera system, computer system, gripping system, and other components.

FIG. 12 shows another embodiment of a stick user interface device with a robotic arm which can slide and increase its length to cover the projector camera system, other sub system or sensor.

FIG. 13 is a detailed high-level block diagram of the software and hardware system of the stick user interface device.

FIG. 14 shows a stick user interface device communicating with another computing device or stick user interface device using a wired or wireless network interface.

FIG. 15 is a flowchart showing the high-level functionality of an exemplary implementation of this invention.

FIG. 16 is a flowchart showing the high-level functionality, algorithm, and methods of the user interface system including object augmentation, gesture detection, and interaction methods or styles.

FIG. 17 is a table of exemplary API (Application programming Interface) methods.

FIG. 18 is a table of exemplary interaction methods on the user-interface.

FIG. 19 is a table of exemplary user interface elements.

FIG. 20 is a table of exemplary gesture methods.

FIG. 21 shows a list of basic gesture recognition methods.

FIG. 22 shows a list of basic computer vision methods.

FIG. 23 shows another list of basic computer vision methods.

FIG. 24 shows a list of exemplary tools.

FIG. 25 shows a list of exemplary application specific devices and sensors.

FIG. 26 shows a front view of the piston pump based vacuum system.

FIG. 27 shows a front view of the vacuum generator system.

FIG. 28 shows a front view of the vacuum generator system using pistons compression technology.

FIG. 29 shows a gripping or sticking mechanism using electro adhesion technology.

FIG. 30 shows a mechanical gripper or hook.

FIG. 31 shows a front view of the vacuum suction cups before and after sticking or gripping.

FIG. 32 shows a socket like mechanical gripper or hook.

FIG. 33 shows a magnetic gripper or sticker.

FIG. 34 shows a front view of another alternative embodiment of the projector camera system, which uses a series of mirrors and lenses to navigate projection.

FIG. 35 shows a stick user interface device in charging state during docking.

FIG. 36 shows multi-touch interaction such as typing using both hands.

FIG. 37 shows select interaction to perform copy, paste, delete operations.

FIG. 38 shows two finger multi-touch interaction such as zoom-in, zoom-out operation.

FIG. 39 shows multi-touch interaction to perform drag or slide operation.

FIG. 40 shows multi-touch interaction with augmented objects and user interface elements.

FIG. 41 shows multi-touch interaction to perform copy paste operation.

FIG. 42 shows multi-touch interaction to perform select or press operation.

FIG. 43 shows an example where the body can be used as a projection surface to display augmented objects and user interface.

FIG. 44 shows an example where the user is giving command to the device using gestures.

FIG. 45 shows how users can interact with a stick user interface device equipped with a projector-camera pair, projecting user-interface on the glass window, converting surfaces into a virtual interactive computing surface.

FIG. 46 shows an example of the user performing a computer-supported cooperative task using a stick user interface device.

FIG. 47 shows application of a stick user interface device, projecting user-interface on surface to provide assistance during playing piano or musical performance.

FIG. 48 shows application of a stick user interface device, projecting user-interface on surface for navigational assistance in a car.

FIG. 49 shows application of a stick user interface device, projecting user-interface on surface for navigational assistance in a bus or vehicle.

FIG. 50 shows application of a stick user interface device, projecting user-interface on surface to provide assistance during cooking in the kitchen.

FIG. 51 shows application of a stick user interface device, projecting user-interface on surface in bathroom during the shower.

FIG. 52 shows application of a stick user interface device, projecting a large screen user-interface by stitching individual small screen projection.

FIG. 53 shows application of a stick user interface device, projecting user-interface on surface for unlocking door using a projected interface, voice, face (3D) and finger recognition.

FIG. 54. shows application of a stick user interface device, projecting user-interface on surface for assistance during painting, designing or crafting.

FIG. 55 shows application of a stick user interface device, projecting user-interface on surface for assistance to learn dancing.

FIG. 56 shows application of a stick user interface device, projecting user-interface on surface for navigational assistance to play games, for example on pool table.

FIG. 57 shows application of a stick user interface device, projecting user-interface on surface for navigational assistance on tree trunk.

FIG. 58 shows application of a stick user interface device, projecting user-interface on surface for navigational assistance during walking.

FIG. 59 shows application of two devices, creating a virtual window, by exchanging camera images (video), and projecting on wall.

FIG. 60 shows application of stick user interface device augmenting a clock application on the wall.

FIG. 61 shows application of a stick user interface device in outer space.

FIGS. 62A and 62B show embodiments containing application subsystems and user interface sub systems.

FIG. 63 shows an application of a stick user interface device where the device can be used to transmit power, energy, signals, data, internet, Wi-Fi, Li-Fi, etc. from source to another device such as laptop wirelessly.

FIG. 63 shows embodiment containing only the application subsystem.

FIG. 64 shows a stick user interface device equipped with an application specific sensor, tools or device, for example a light bulb.

FIG. 65 shows a stick user interface device equipped with a printing device performing printing or crafting operation.

FIG. 66A and FIG. 66B show image pre-processing to correct or wrap projection image into rectangular shape using computer vision and control algorithms.

FIG. 67 shows various states of device such as un-folding, sticking, projecting, etc.

FIG. 68 shows how the device can estimate pose from wall to projector-camera system and from gripper to sticking surface or docking sub-system using sensors, and computer vision algorithms.

FIG. 69 shows another preferred embodiment of the stick user interface device.

FIG. 70 shows another embodiment of projector camera system with a movable projector with fixed camera system.

### DETAILED DESCRIPTION OF THE INVENTION

The main unique feature of this device is its ability to, stick, and project information using a robotic projector-camera system. In addition, the device can execute application specific task using reconfigurable tools and devices.

Various prior works show how all these individual features or parts were implemented for various existing applications. Projects like “CITY Climber” shows that sustainable surface or wall climbing and sticking is possible using currently available vacuum technologies. One related project called the LUMINAR project shows how a robotic arm can be equipped with devices such as projector-camera for augmented reality applications.

To engineer “Stick User Interface” device we need four basic abilities or functionalities in a single device 1) Device should be able to unfold (in this patent, un-fold means expanding of robotic arms) like a stick in a given medium or space 2) Device should be able to stick to the nearby surface such as ceiling or wall, and 3) Device should be able to provide a user-interface for human interaction and 4) Device should be able to deploy and execute application specific task.

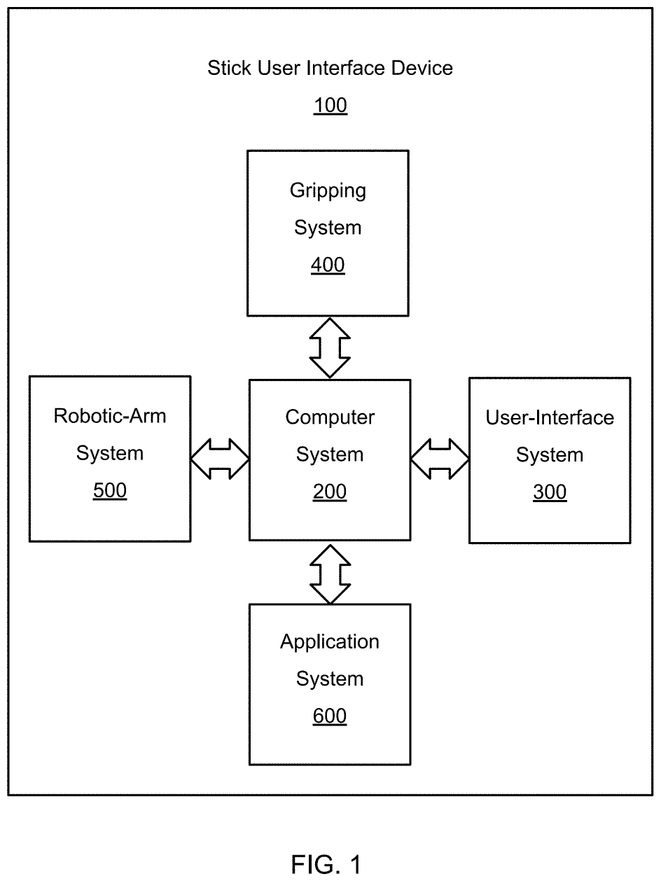

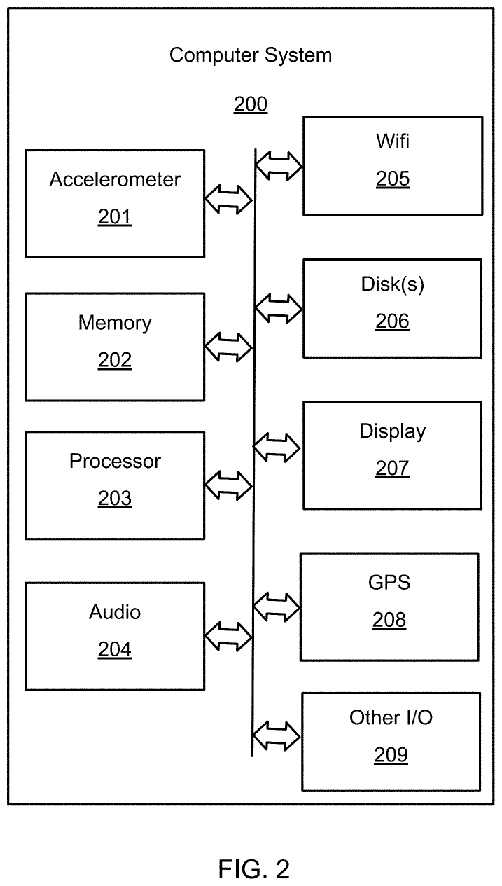

A high-level block diagram in FIG. 1 describes the five basic subsystems of the device such as gripping system 400, user-interface system, computer system 200, and robotic arm interface system 500, and auxiliary application system 600.

Computer system 200 further consists of computing or processing device 203, input output, sensor devices, wireless network controller or Wi-Fi 206, memory 202, display controller such as HDMI output 208, audio or speaker 204, disk 207, gyroscope 205, and other application specific, I/O, sensor or devices 210. In addition, computer system may connect or consists of sensors such a surface sensor to detect surface (like bugs Antenna), proximity sensor such as range, sonar or ultrasound sensors, Laser sensors such as Laser Detection And Ranging (LADAR), barometer, accelerometer 201, compass, GPS 209, gyroscope, microphone, Bluetooth, magnetometer, Inertial measurement unit (IMU), MEMS, Pressure Sensor, Visual Odometer Sensor, and more. The computer system may consist of any state-of-the-art devices. The computer may have Internet or wireless network connectivity. Computer system provides coordination between all sub systems.

Other subsystems (for example grip controller 401) also consist of a small computing device or processor, and may access sensor data directly if required for their functionalities. For example, either a computer can read data from accelerometers and gyroscope or a controller directly access these raw data from sensors and compute parameters using an onboard microprocessor. In another example, a user interface system can use additional speakers or a microphone. The computing device may use any additional processing unit such as Graphical Processing Unit (GPU). Operating system used in a computing device can be real-time and distributed. Computer can combine sensors data such as gyroscope readings, distances or proximity data, 3D range information, and make control decision for robotic arm, PID control, Robot odometry estimation (using control commands, odometry sensors, velocity sensors), navigation using various state of the art control, computer vision, graphics, machine learning, and robotic algorithm.

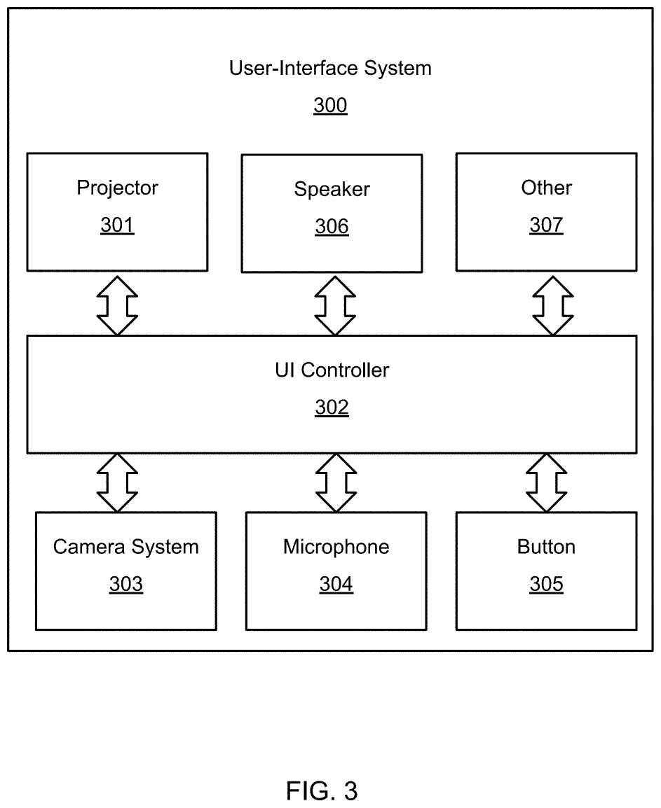

User interface system 300 further contains projector 301, UI controller 302, and camera System (one or more cameras) 303 to detect depth using stereo vision. User interface may contain additional input devices such as microphone 304, button 305, etc., and output devices such as speakers, etc. as shown in FIG. 3.

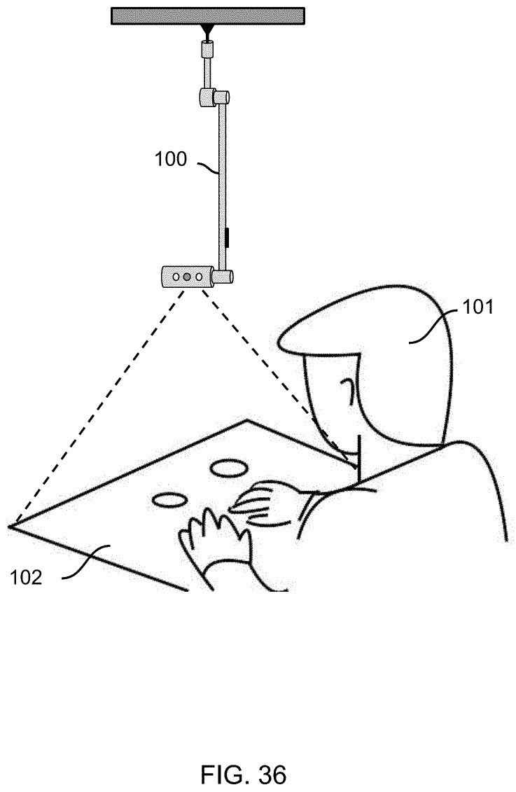

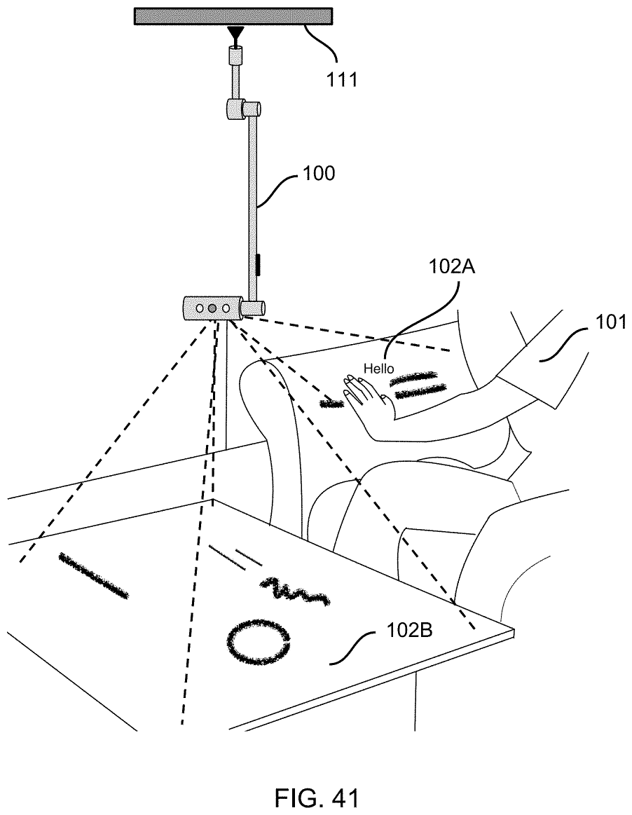

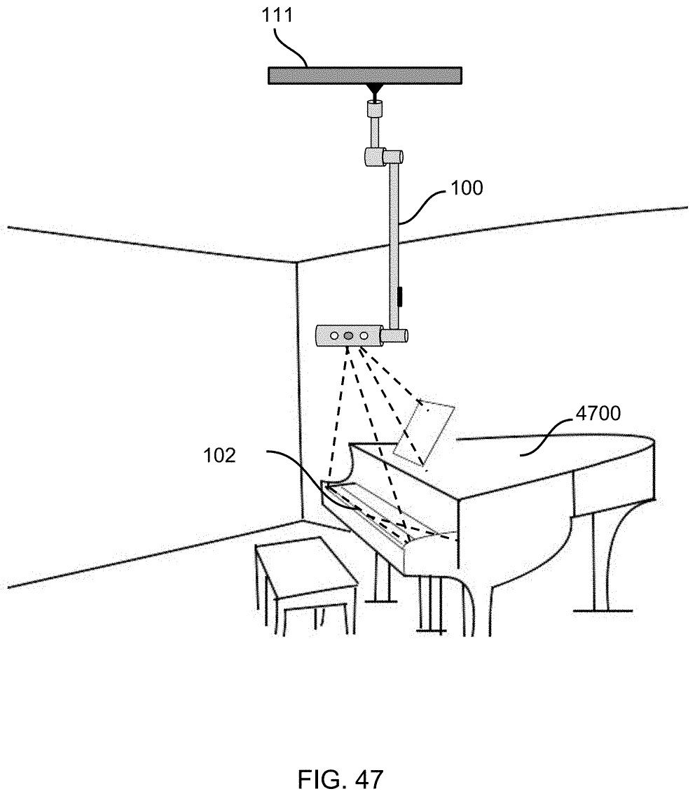

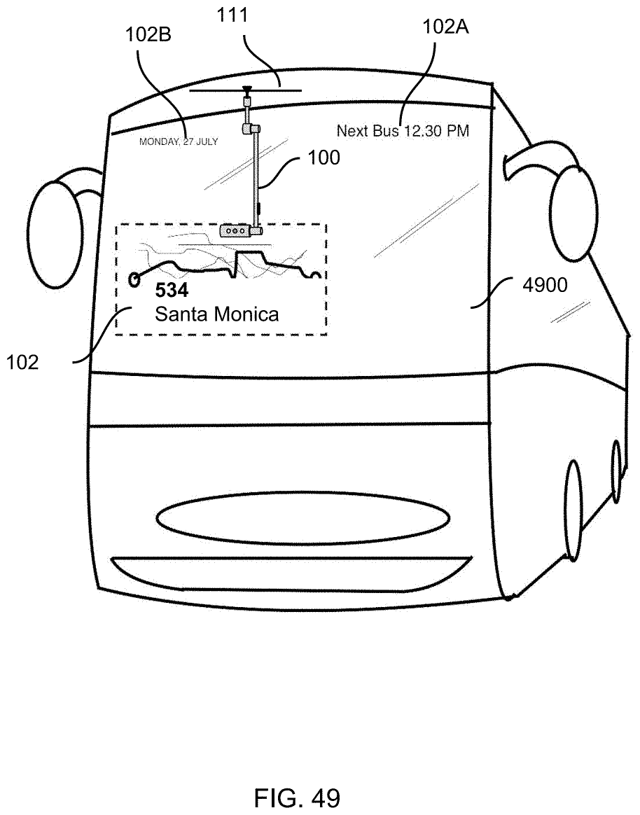

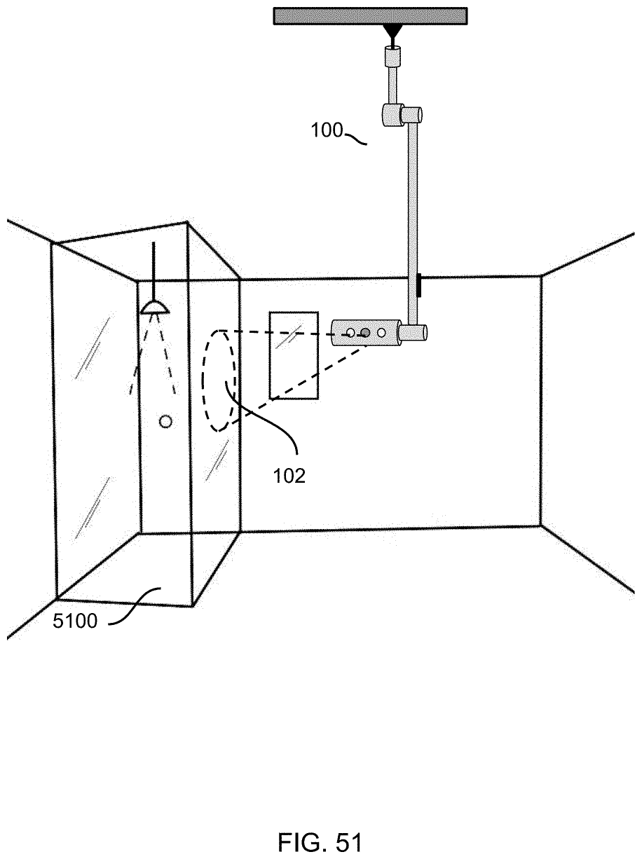

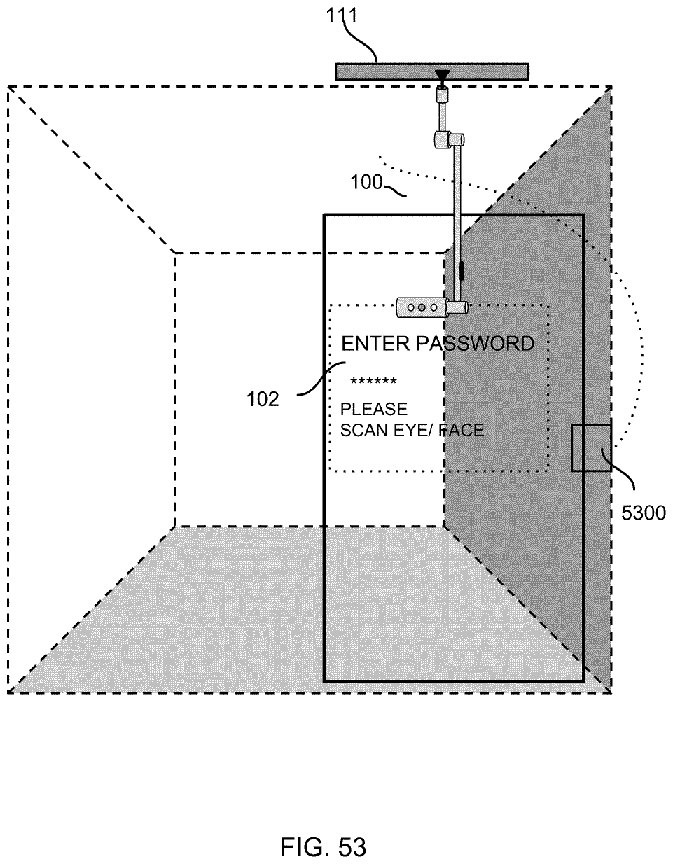

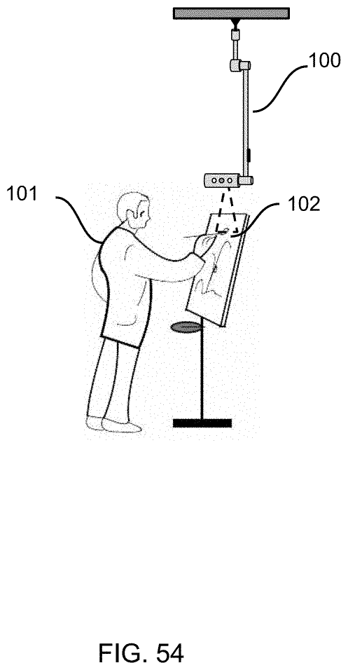

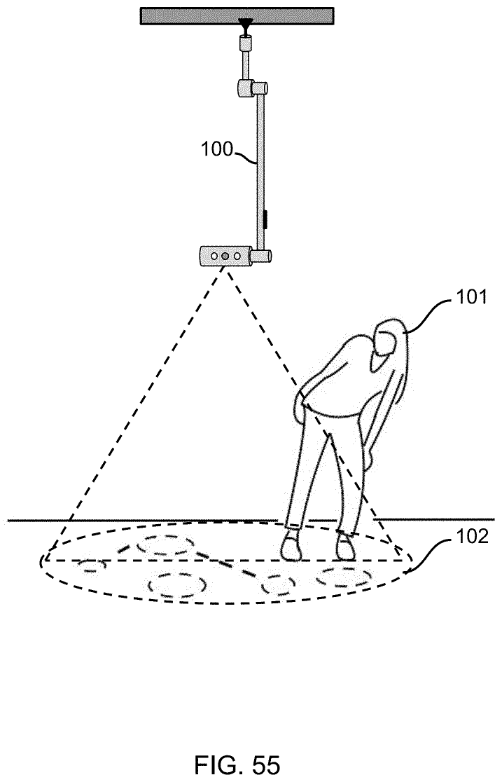

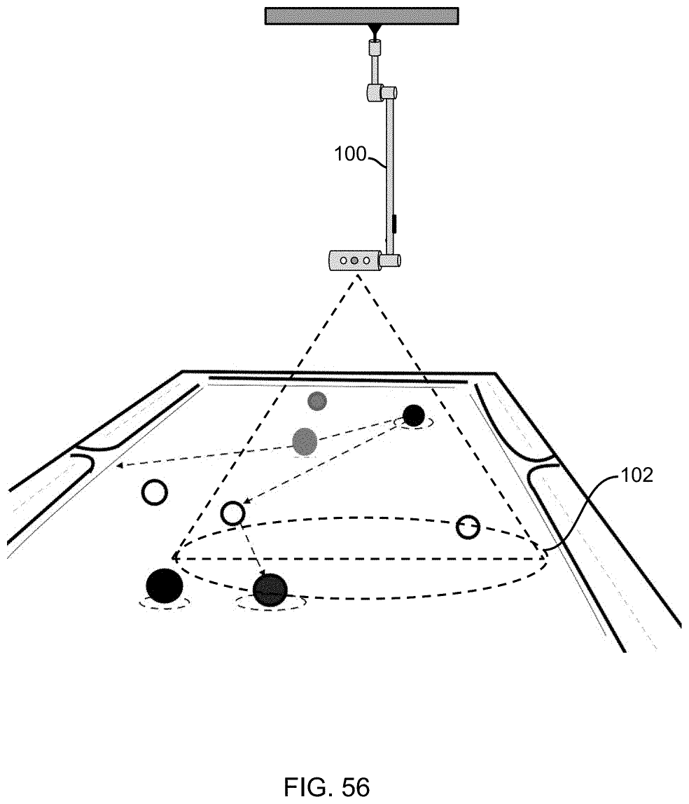

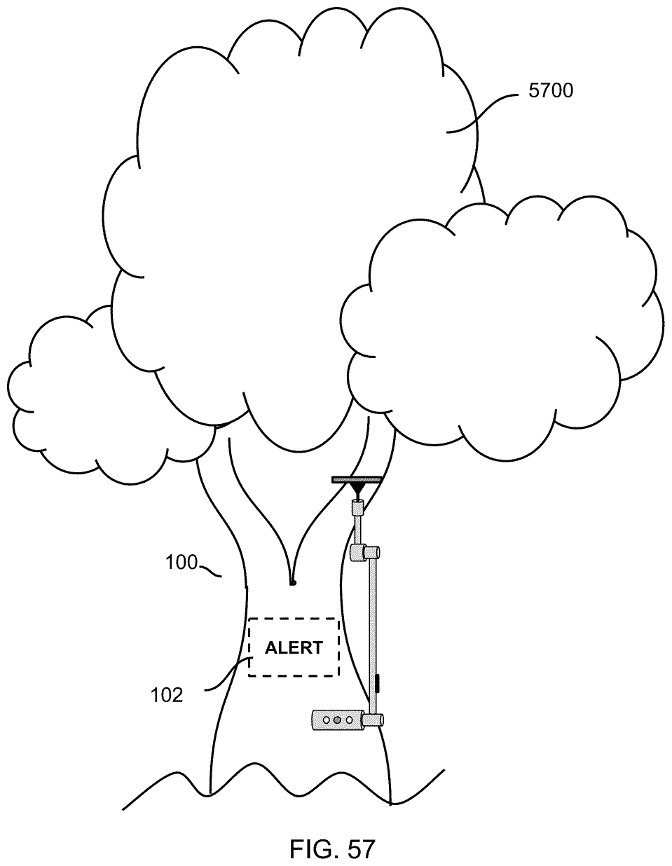

User interface system provides augmented reality based human interaction as shown in FIGS. 36, 37, 38, 39, 40, 41, 42, 43, 44, 45, 46, 47, 48, 49, 50, 51, 52, 53, 54, 55, 56, 57, 58, 59 and 60.

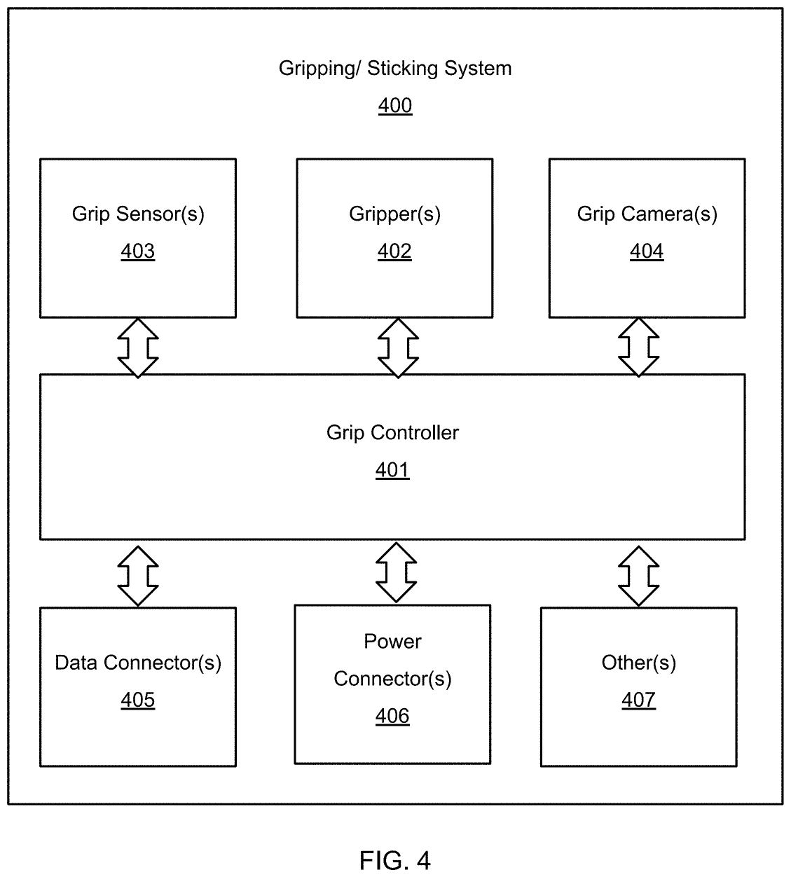

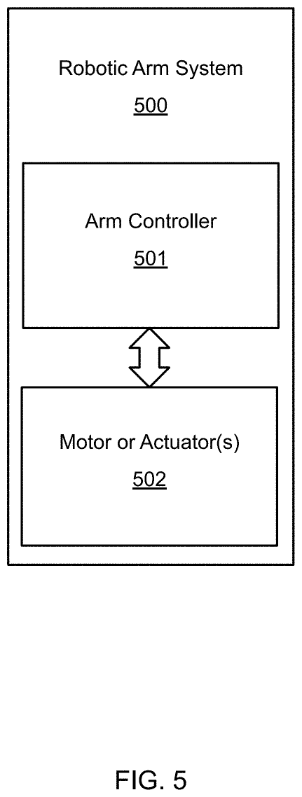

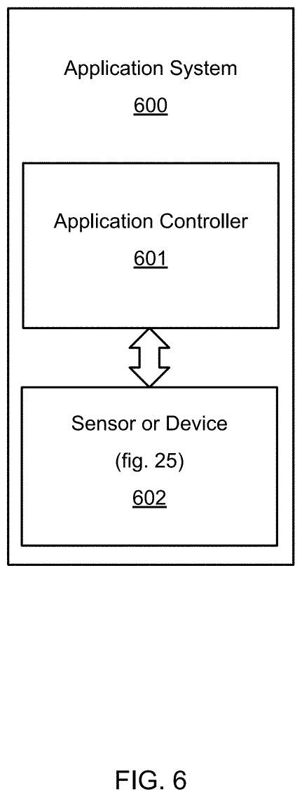

Gripping system 400 further contains grip controller 401 that controls gripper 402 such as vacuum based gripper, grip cameras(s) 404, data connector 405, power connector, and other sensors or device 407 as shown in FIG. 4.

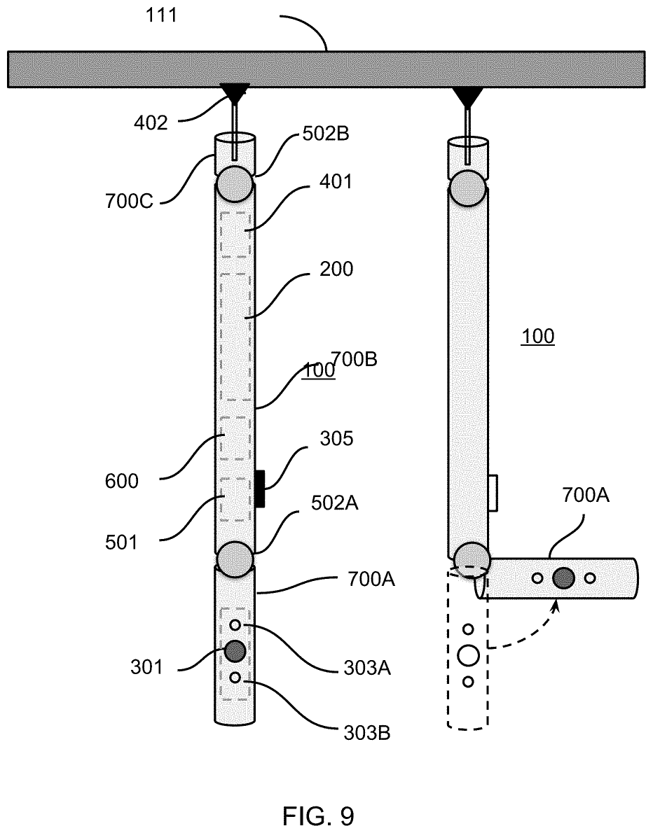

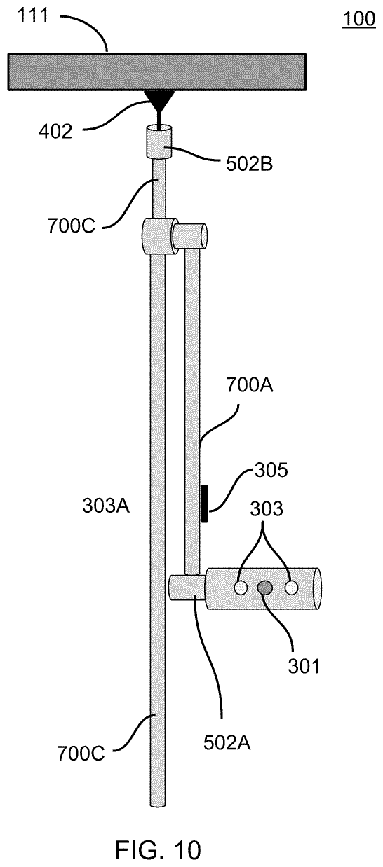

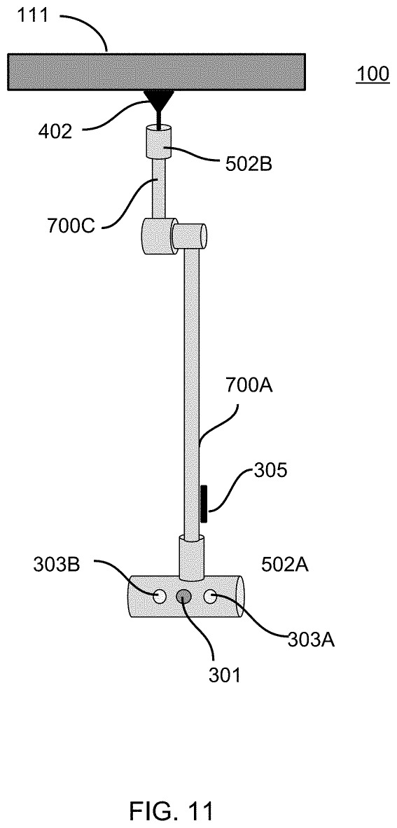

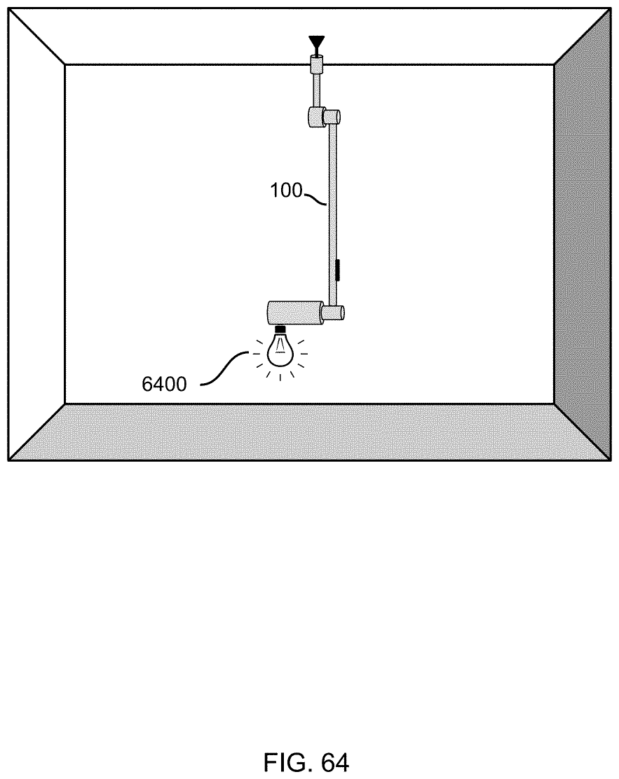

Robotic Arm System 500 further contains Arm controller 501, one or more motor or actuator 502. Robotic arm contains and holds all subsystems including additional application specific devices and tools. For example, we can equip a light bulb shown in FIG. 64. The robotic arm may have arbitrary degrees of freedom. System may have multiple robotic arms as shown in FIG. 9. Robotic arm may contain other system components, computer, electronics, inside or outside of the arm. Arm links may be any combination of any type of joints such as revolute joint and prismatic. Arm can slide using a linear-motion bearing or linear slide to provide free motion in one direction.

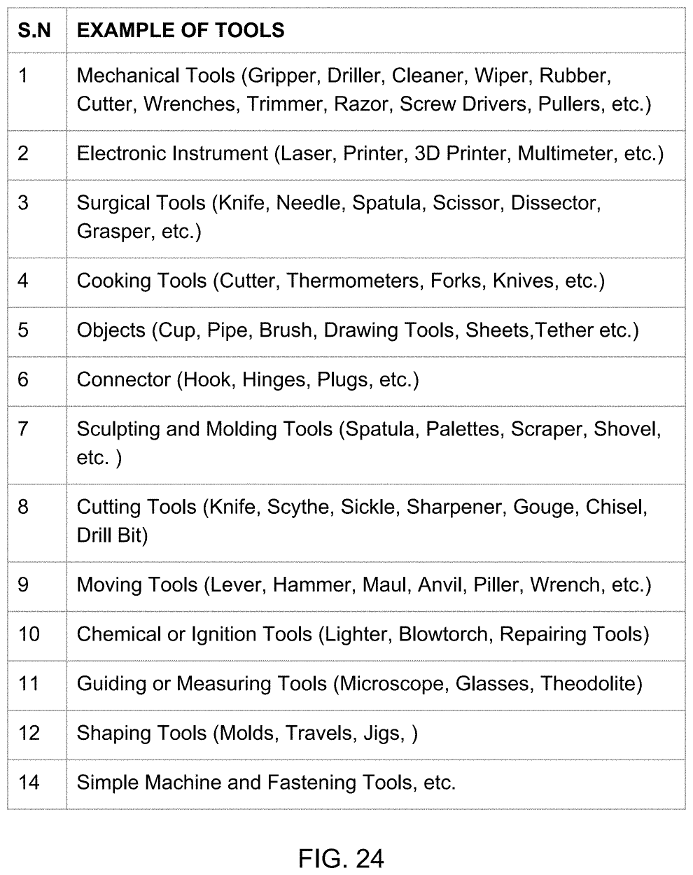

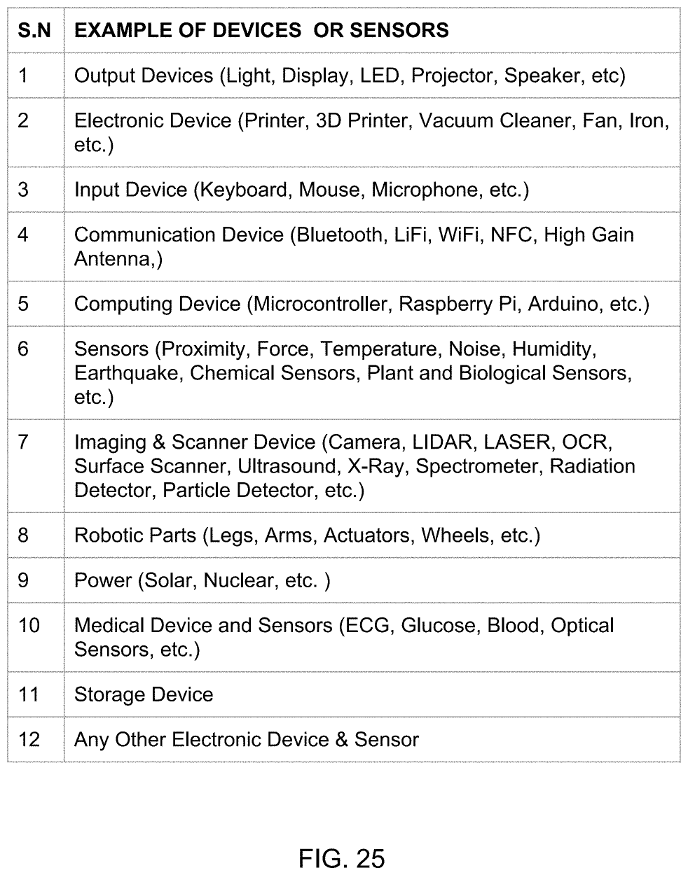

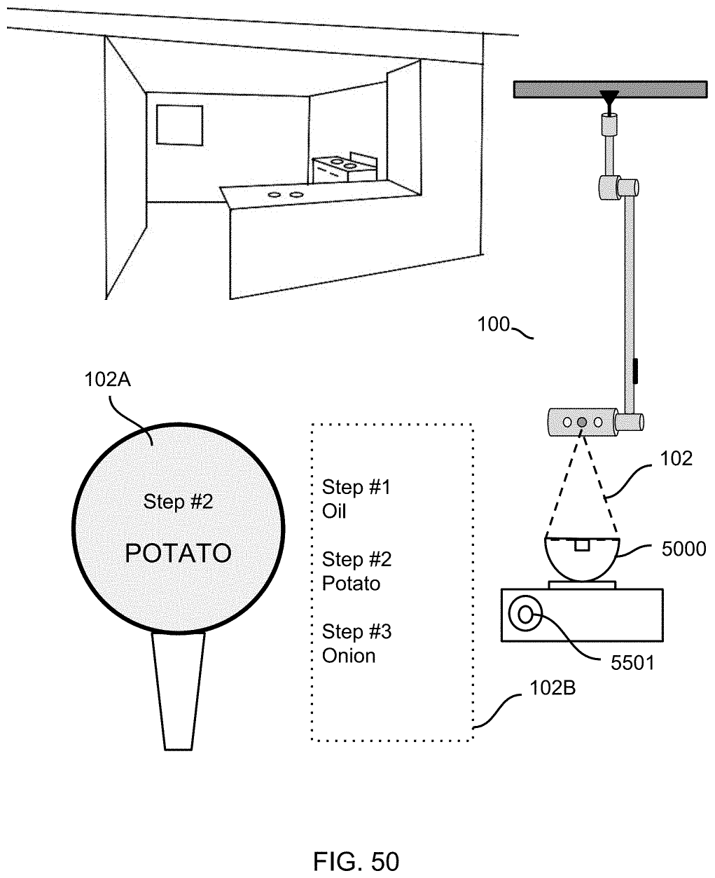

Application System 600 contains application specific tools and devices. For example, for the cooking application described in FIG. 50, the system may use a thermal camera to detect the temperature of the food. The thermal camera also helps to detect humans. In another example, a system may have a light for the exploration of the dark places or caves as shown in FIG. 64. Application system 600 further contains Device controller 601 that controls application specific devices 602. Some of the examples of the devices are listed in tables in FIGS. 24 and 25.

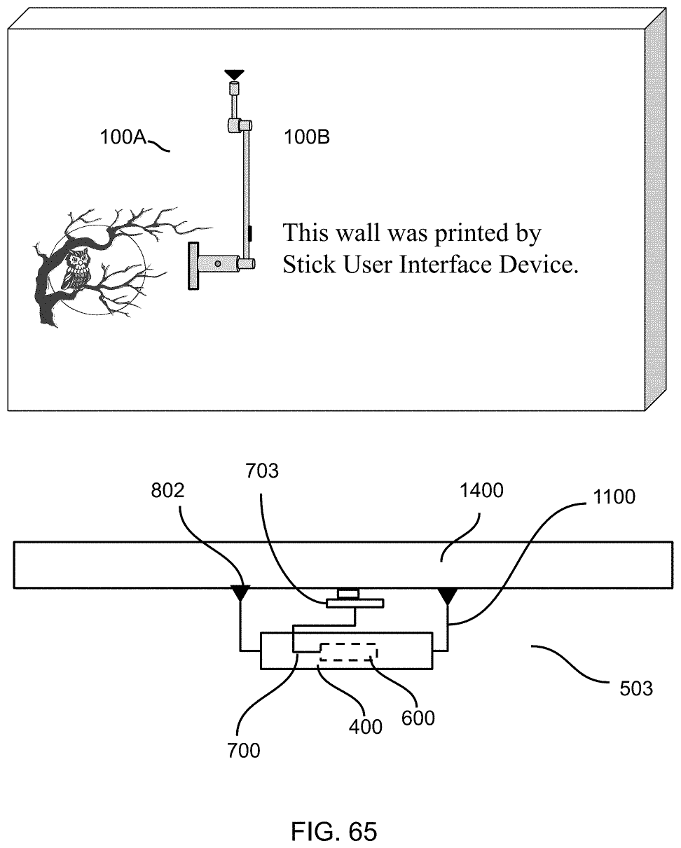

To connect or interface any application specific device to the Robotic Arm System 500 or Application System 600 mechanical hinges, connectors, plugs, joints, can be used. An application specific device can communicate with the rest of the system using hardware and software interface. For example, if you want to add a printer to the device, all you have to do is to add a small printing system to the application interface connectors, and configure the software to instruct the printing task as shown in FIG. 65. Various mechanical tools can be fit into the arms using hinges or plugs.

System has the ability to change its shape using motors and actuators for some applications. For example, when a device is not in use, it can fold them inside the main body. This is a very important feature, especially when this device is used as a consumer product. It also helps to protect various subsystems from the external environment. Computer instructs the shape controller to obtain desired the shape for a given operation or process. System may use any other type of mechanical, chemical, and electronic shape actuators.

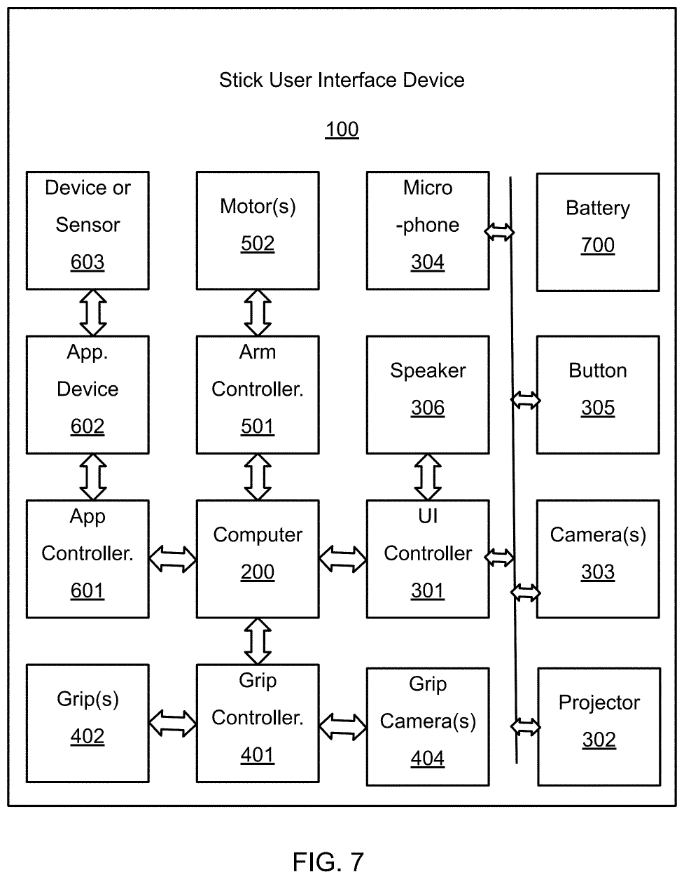

Finally, FIG. 07 shows a detailed high-level block diagram of the stick user interface device connecting all subsystems including power 700. System may have any additional device and controller. Any available state of the art method, technology or devices can be configured to implement these subsystems to perform device function. For example, we can use a magnetic gripper instead of a vacuum gripper in a gripping subsystem or we can use a holographic projector as a projection technology as a display device in a computer for specific user-interface applications.

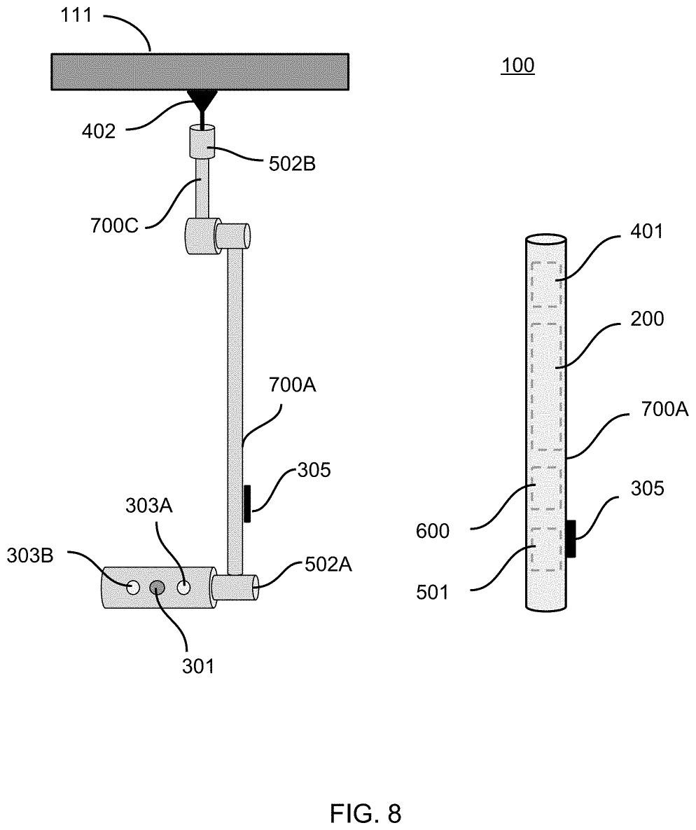

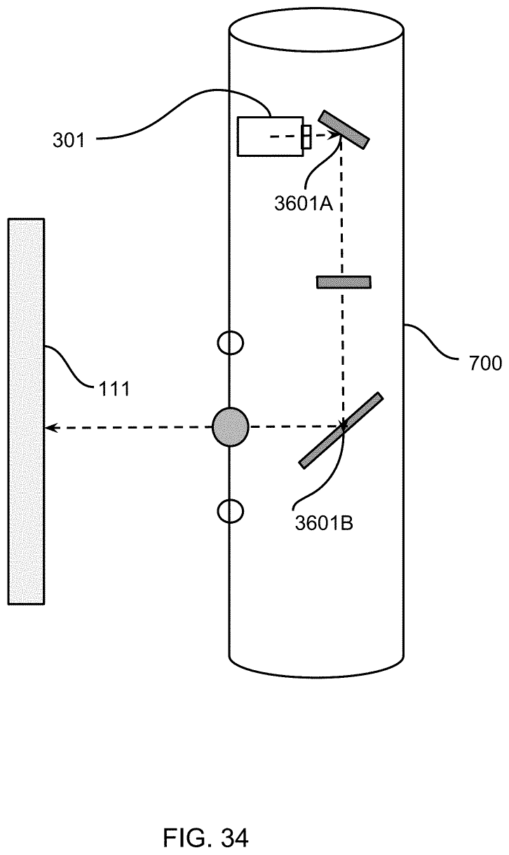

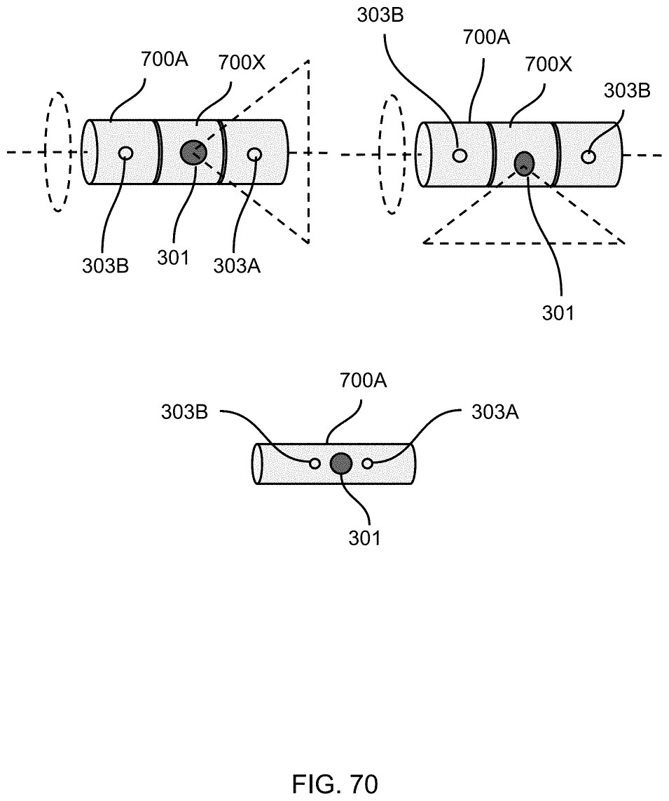

To solve the problem of augmenting information on any surface conveniently, we attached a projector camera system to a robotic arm, containing a projector 301 and two sets of cameras 303 (stereoscopic vision) to detect depth information of the given scene as shown in FIG. 8. Arms generally un-folds automatically during the operation, and folds after the completion of the task. The system may have multiple sets of arms connected with links with arbitrary degrees of freedom to reach nearby surface area or to execute application specific tasks. For example, in FIG. 8, embodiment has one base arm 700C which has ability to rotate 360 (where rotation axis is perpendicular to the frame of the device). Middle arm 700B is connected with the base arm 700C from the top and lower arm 700A. Combination of all rotation in all arms assists to project any information on any nearby surface with minimum motion. Two cameras also help to detect surfaces including the surface where the device has to be attached. System may also use additional sensors to detect depth such as a LASER sensor, or any commercial depth sensing device such as Microsoft KINECT. The projector camera system also use additional cameras such as front or rear cameras or use one set of robotic camera pairs to view all directions. Projector may also use a mirror or lenses to change direction of the projection as shown in FIG. 34. Direction changing procedure could be robotic. Length of the arms and degree of freedoms may vary, depending on the design, application, and size of the device. Some applications only require one degree of freedom whereas other two or three, or arbitrary, degrees of freedoms. In some embodiments, the projector can be movable with respect to camera(s) as shown in FIG. 70.

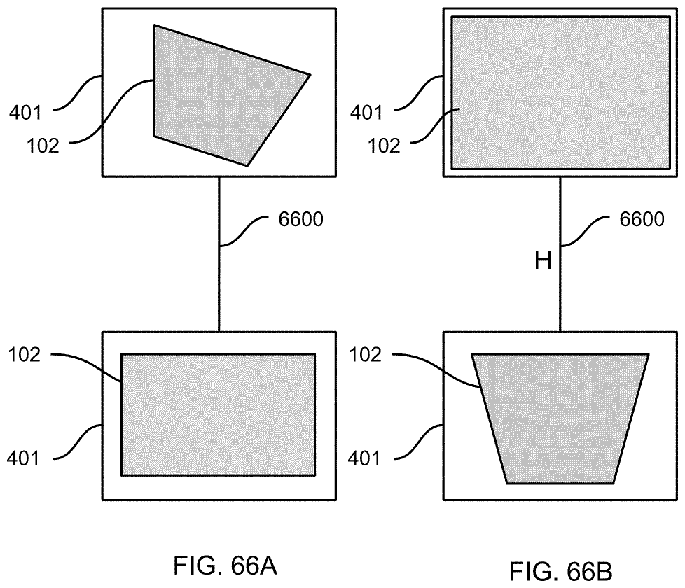

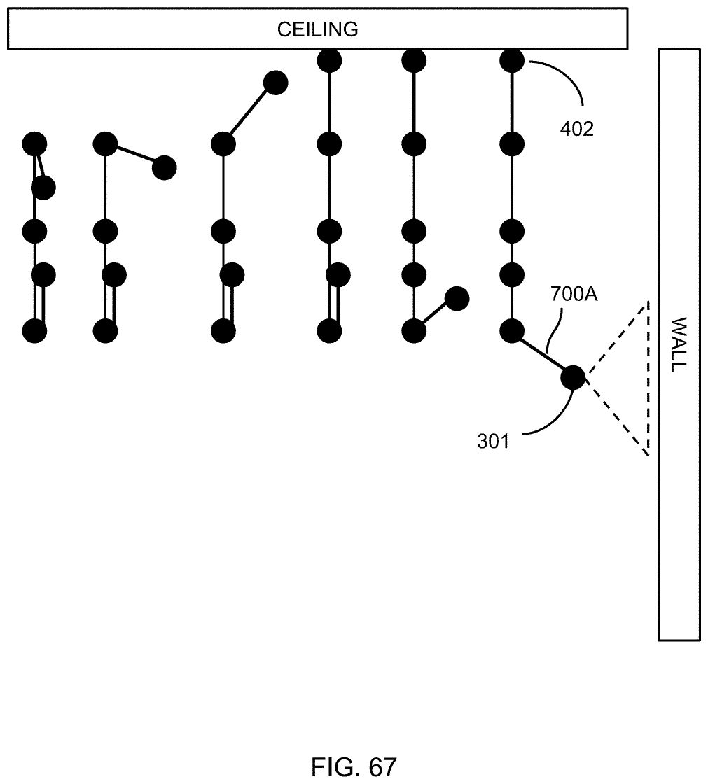

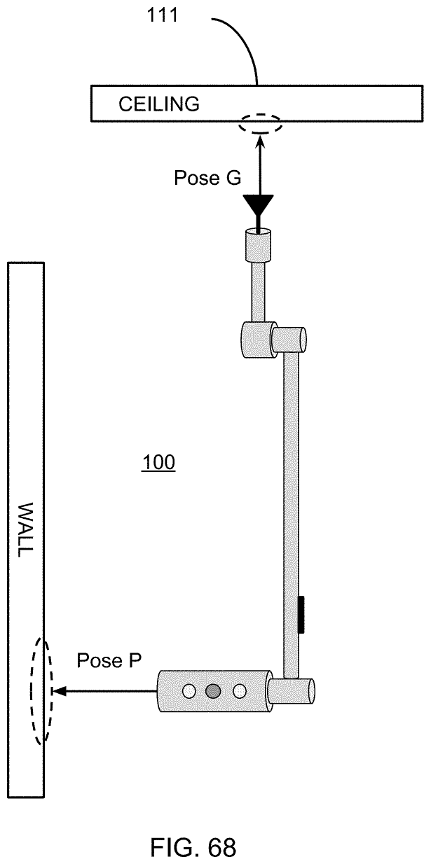

System can correct projection alignment using computer vision-based algorithms as shown in FIG. 66. This correction is done by applying image-warping transformation to the application user interface within computer display output. An example of an existing method can be read at http://www.cs.cmu.edu/˜rahuls/pub/iccv2001-rahuls.pdf. In another approach, a robotic actuator can be used to correct projection with the help of a depth-map computed with a projector camera system using gradient descent method.

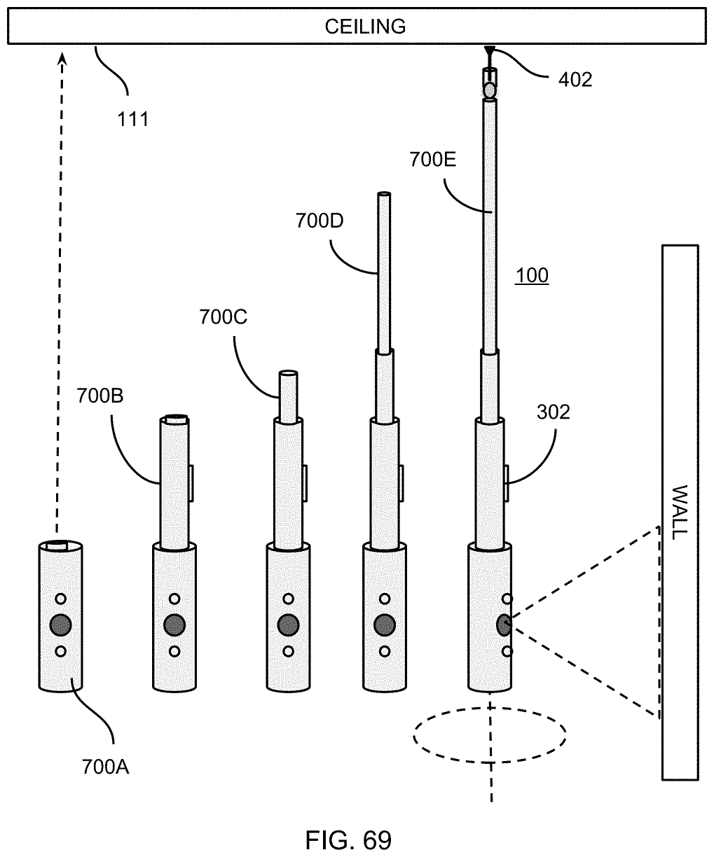

In another preferred embodiment, all robotic links or arms such as 700A, 700B, 700C, 700D, and 700E fold in one direction, and can rotate as shown in FIG. 69. For example, arms equipped with a projector camera system can move to change the direction of the projector as shown.

The computer can estimate the pose of a gripper with respect to a sticking surface such as ceiling, using its camera and sensors, by executing computer vision based using single image, stereo vision, or image sequences. Similarly, the computer can estimate pose of the projector-camera system from the projection surface. Pose estimation can be done using calibrated or uncalibrated camera, analytic or geometric methods, marker based, marker less methods, image-based registration, genetic algorithm, or machine learning based methods. Various open-source libraries can be used for this purpose such as OpenCV, Point Cloud Library, VTK, etc.

Pose estimation can be used for motion planning, navigation using standard control algorithms such as PID control. System can use inverse kinematics equations to determine the joint parameters that provide a desired position for each of the robot's end-effectors. Some of the example of motion planning algorithm are Grid based approach Interval based search, Geometric algorithm, Reward based search, sampling-based search, A*, D*, Rapidly-exploring random tree, and Probabilistic roadmap.

To solve the problem of executing any application specific task, we designed a hardware and software interface that connects tools with this device. Hardware interface may consist of electrical or mechanical interface required for interfacing with any desired tool. Weight and Size of tool or payload depends on the device's ability to carry. Application subsystems and controller 601 are used for this purpose. FIG. 65 shows an example of embodiment which uses application specific subsystem such as a small-printing device.

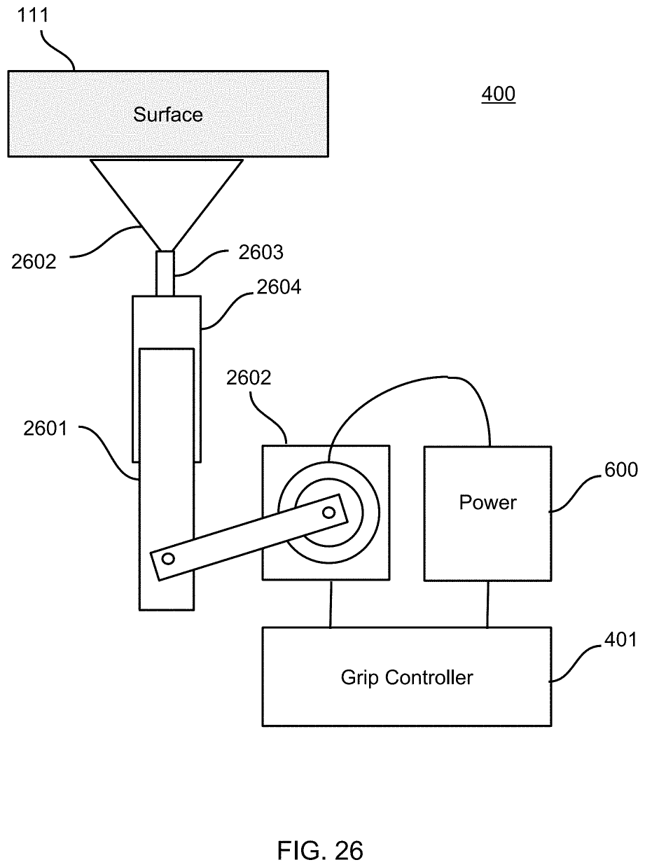

To solve the problem of sticking to a surface 111, we can use a basic mechanical component called vacuum gripping system shown in FIGS. 26, 27, 28, and 31 that are generally used in the mechanical or robotics industry for picking or grabbing objects. Vacuum gripping system has three main components; 1) Vacuum suction cups, which are the interface between vacuum system and the surface. 2) Vacuum generator, which generates vacuum using motor, ejectors, pumps or blowers. 3) Connectors or tubes 803 that connect suction cups to the vacuum generator via vacuum chamber. In this prototype, we have experimented with a gripper (vacuum suction cups), but their quantity may vary from one to many, depending on the type of surface, and ability to grip by the hardware, weight of the whole device, and height of the device from ground. Four grippers are mounted to the frame of the device. All four vacuum grippers are connected to a centralized (or decentralized) vacuum generator via tubes. When vacuum is generated, grippers suck the air, and stick to the nearby surface. We may optionally use a sonar or (Infrared) IR surface detector sensor (because two stereoscopic cameras can be used to detect the surface). In an advanced prototype, we can also use switches and filters to monitor and control the vacuum system.

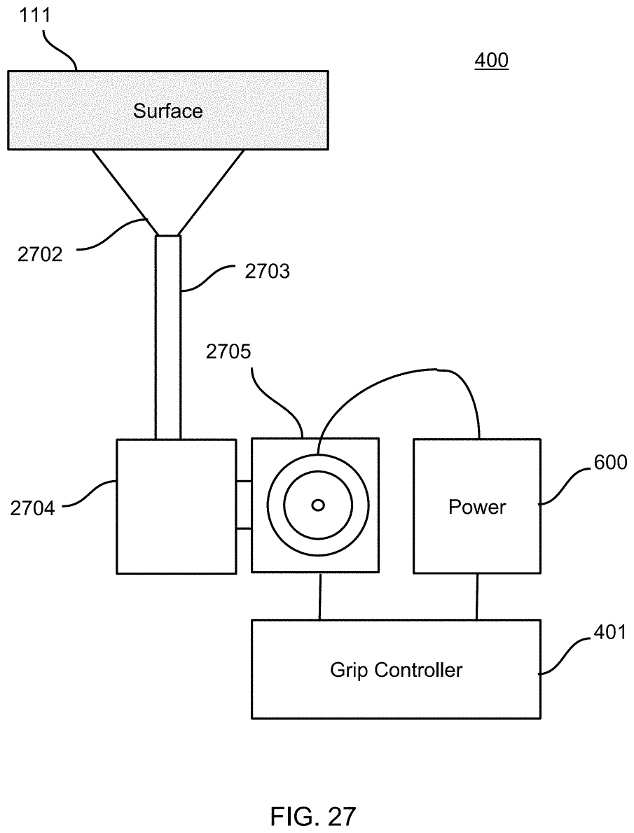

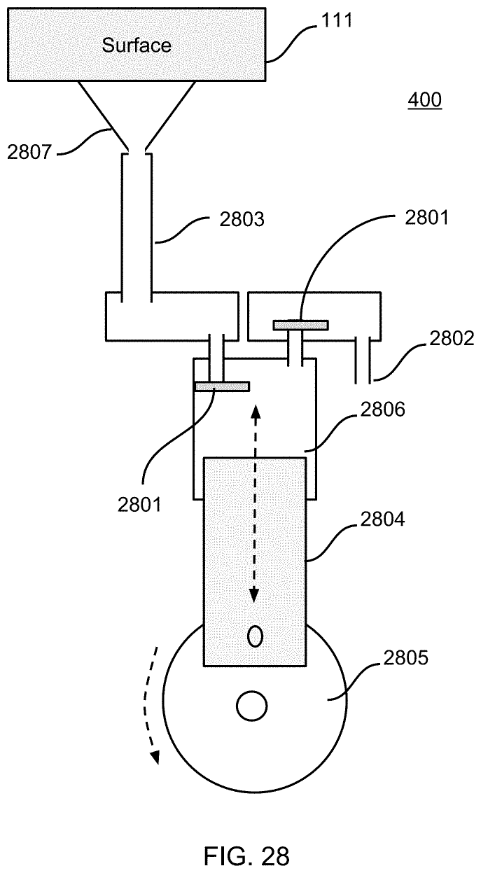

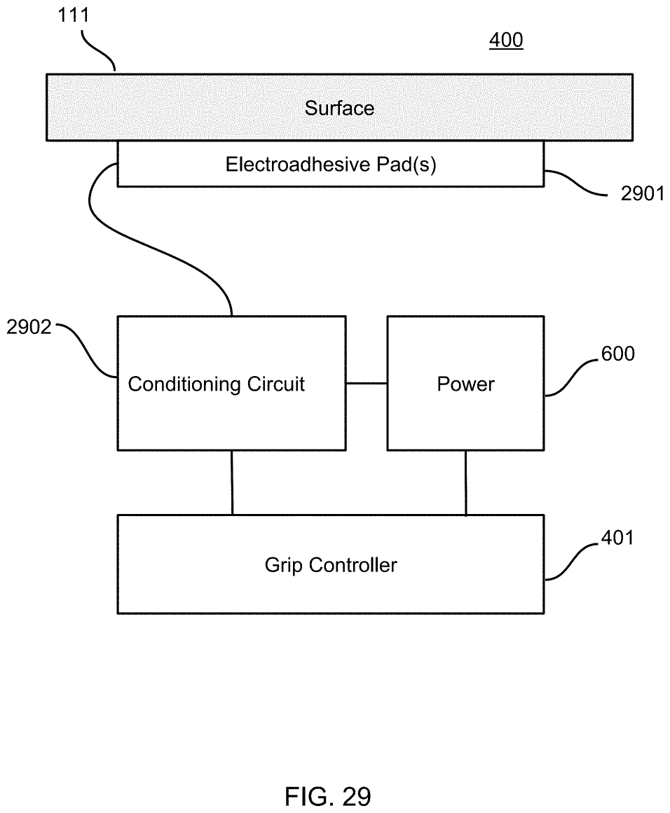

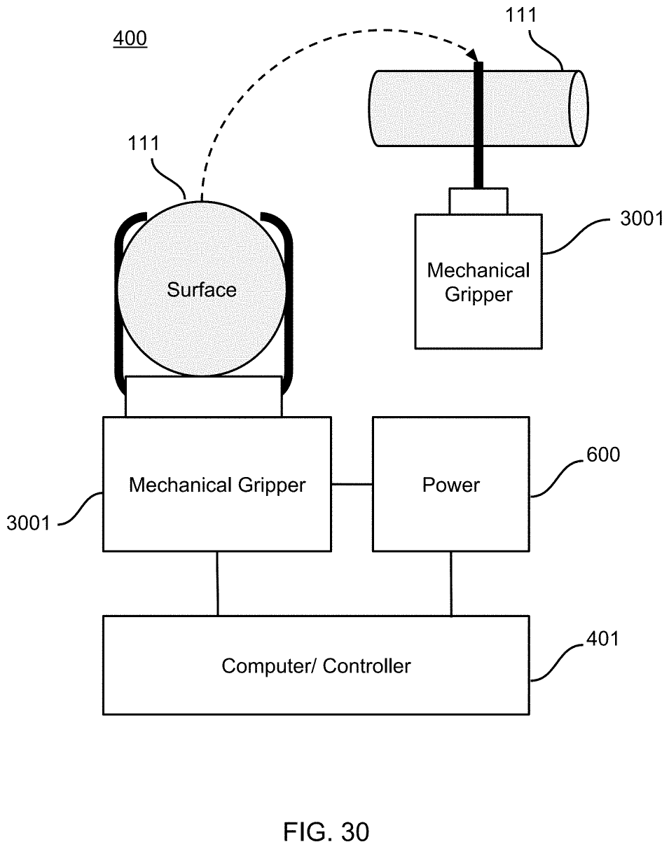

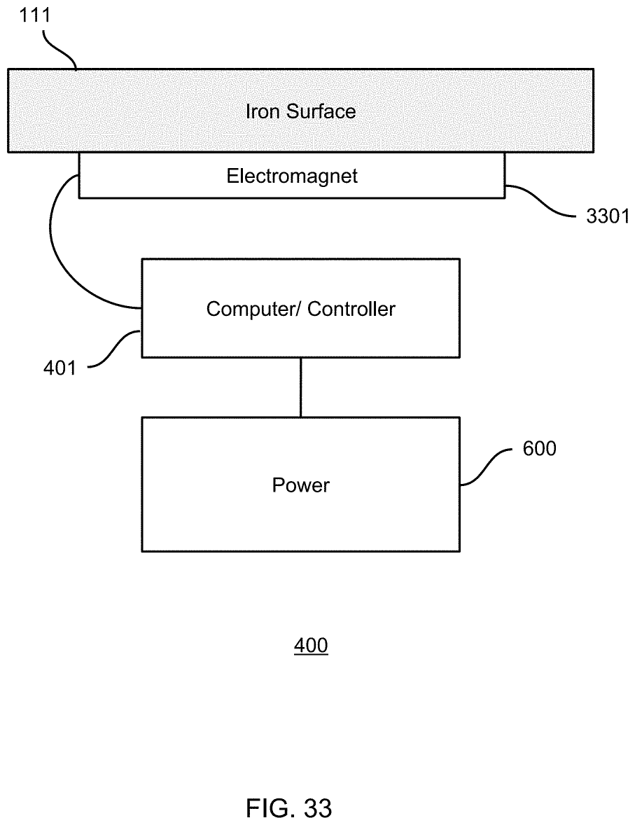

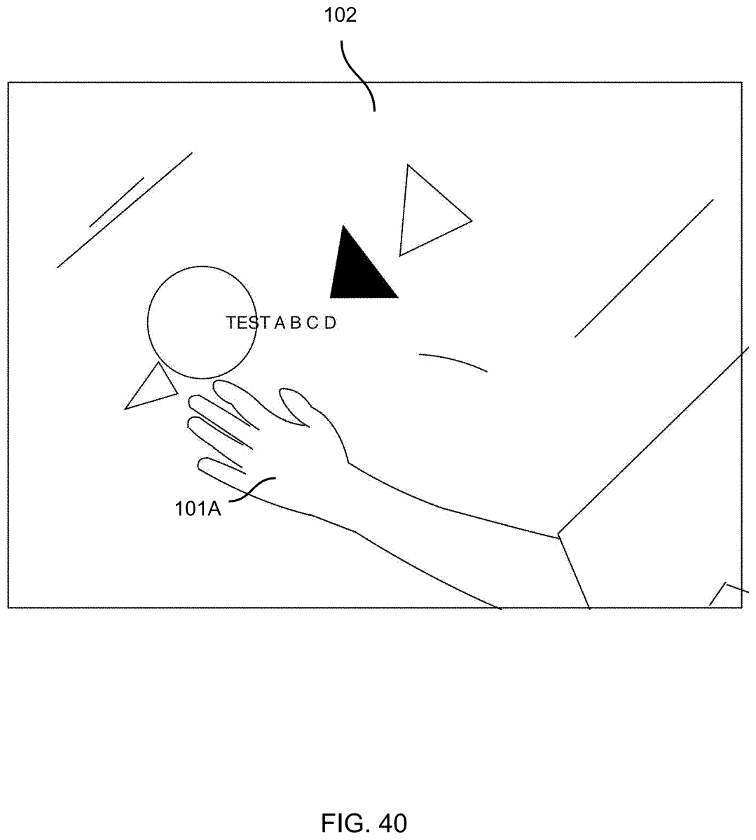

FIG. 26 shows a simple vacuum system, which consists of vacuum gripper or suction cup 2602, pump 2604 controlled by a vacuum generator 2602. FIG. 27 shows a compressor based vacuum generator. FIG. 28 shows the internal mechanism of a piston-based vacuum where vacuum is generated using a piston 2804 and plates (intake or exhaust valve) 2801 attached to the openings of the vacuum chamber. Note in theory, we can also use other types of grippers that depend on the nature of the surface. For example, magnetic grippers 3301 can be used to stick to the iron surfaces of machines, containers, cars, trucks, trains, etc. as shown in FIG. 33. Sometimes your magnetic surface can be used to create a docking or hook system, where the device can attach using a magnetic field. In another example, electroadhesion (U.S. Pt. No. 7,551,419B2) technology can be used to stick as shown in FIG. 29 where electro adhesive pads 2901 sticks to the surface using a conditioning circuit 2902 and a grip controller 401. To grip rods like material, mechanical gripper 3001 can be used as shown in FIG. 30. FIG. 40 shows an example of a mechanical socket-based docking system, where two bodies can be docked using an electro-mechanical mechanism using moving bodies 3202.

To solve the problem of executing tasks on surface or nearby objects conveniently, we designed a robotic arm containing all sub systems such as computers subsystem, gripping subsystem, user-interface subsystem, and application subsystem. Robotic arm generally folds automatically during the rest mode, and unfolds during the operation. Combination of all rotation in all arms assists to reach on any nearby surface with minimum motion requirement. Two cameras also help to detect surfaces including the surface where the device has to be attached. Various facts about arms may vary such as length of the arms, degrees of freedom, rotation directions (such as pitch roll, yaw), depending of the design, application, and size of the device. Some applications only require one degree of freedom whereas other two or three, or more degrees of freedom. Robotic arms may have various links and joints to produce any combination of raw or pitch motion in any direction. The system may use any type of mechanical, electronic, vacuum, etc. approach to produce joint motion. Invention may use other sophisticated bio-inspired robotic arms such as an elephant trunk, or snake like arms.

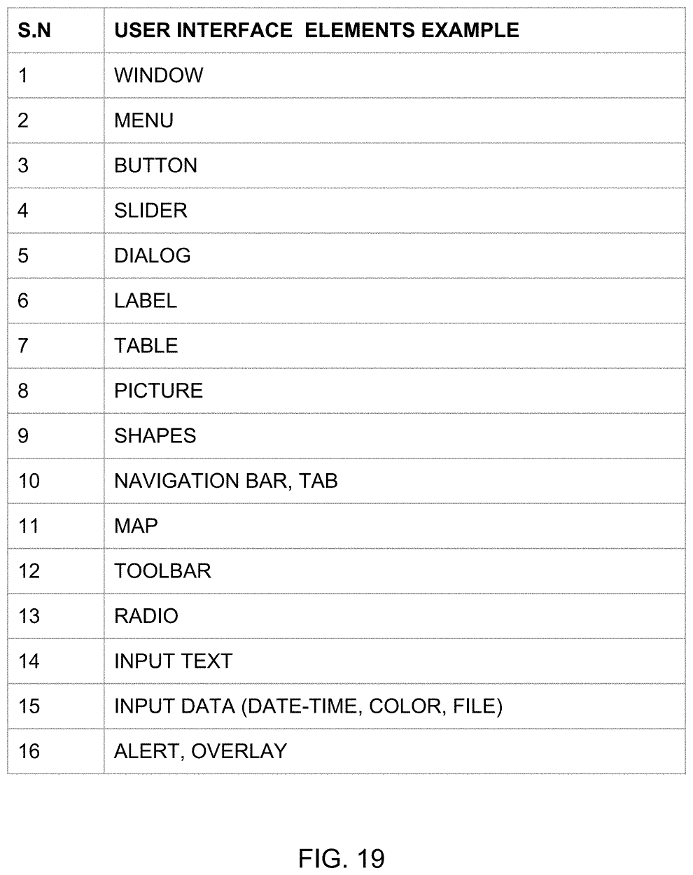

The device can be used for various visualization purposes. Device projects augmented reality projection 102 on any surface (wall, paper, even on the user's body, etc.). The user can interact with the device using sound, gestures, and user interface elements as shown in FIG. 19.

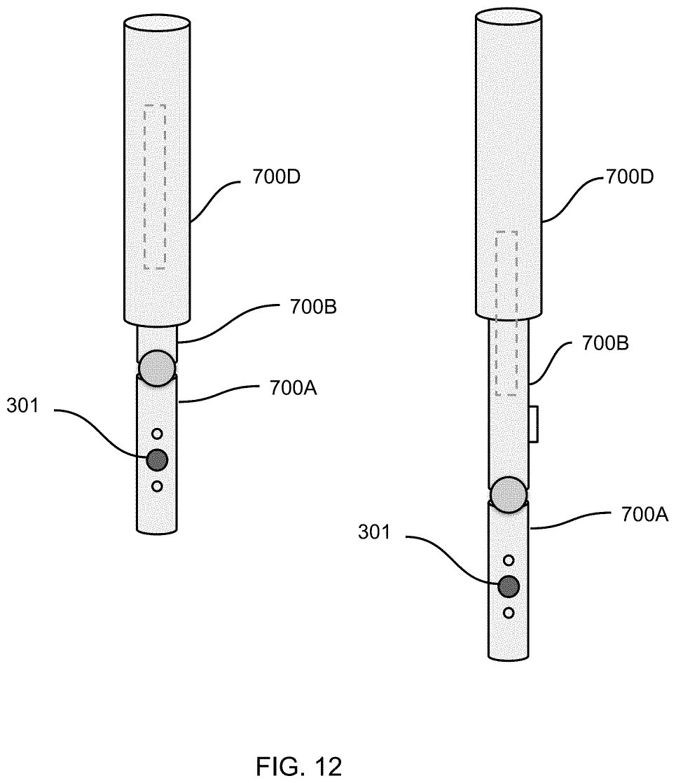

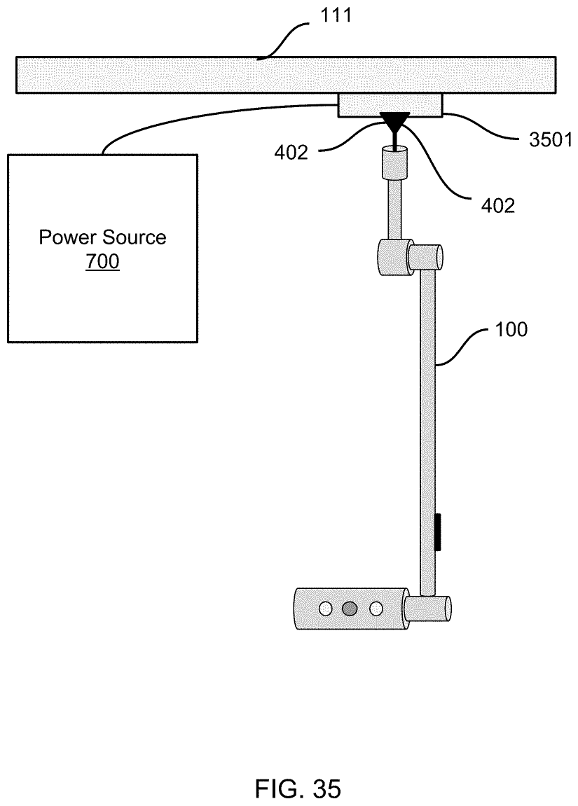

All these main components have their own power sources or may be connected by a centralized power source 700 as shown in FIG. 12. One unique feature of this device is that it can be charged during sticking or docking status from power (recharge) source 700 by connecting to a charging plate 3501 (or induction or wireless charging mechanism) as shown in FIG. 35.

It can also detect free fall during the failed sticking mechanism using onboard accelerometer and gyroscope. During the free fall, it can fold itself in a safer configuration to avoid accidents or damage.

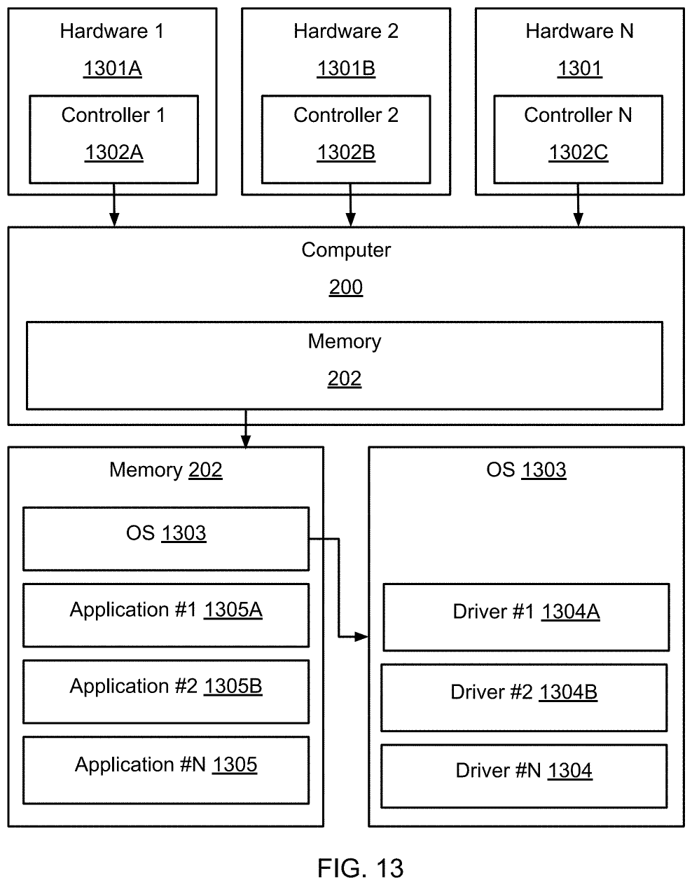

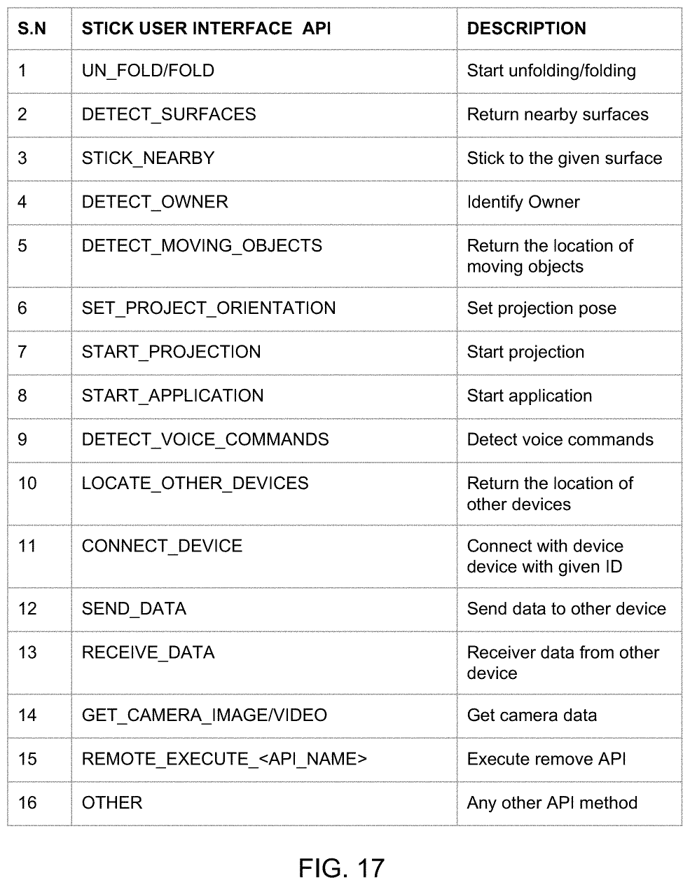

Stick user interface is a futuristic human device interface equipped with a computing device and can be regarded as a portable computing device. You can imagine this device sticking to the surfaces such as ceiling, and projecting or executing tasks on nearby surfaces such as ceiling, wall, etc. FIG. 13 shows how hardware and software are connected and various applications executed on the device. Hardware 1301 is connected to the controller 1302, which is further connected to computer 200. Memory 202 contains operating system 1303, drivers 1304 for respective hardware, and applications 1305. For example, OS is connected to the hardware 1301A-B using controllers 1302A-B and drivers 1304A-B. The OS executes applications 1305A-B. FIG. 17 exhibits some of the basic high-level Application programming Interface (API) to develop computer programs for this device. Because a system contains memory and processor, any kind of software can be executed to support any type of business logic in the same way we use apps or applications on the computers and smartphones. Users can also download computer applications from remote servers (like Apple store for iPhone) for various tasks containing instructions to execute application steps. For example, users can download a cooking application for the assistance during the cooking as shown in FIG. 50.

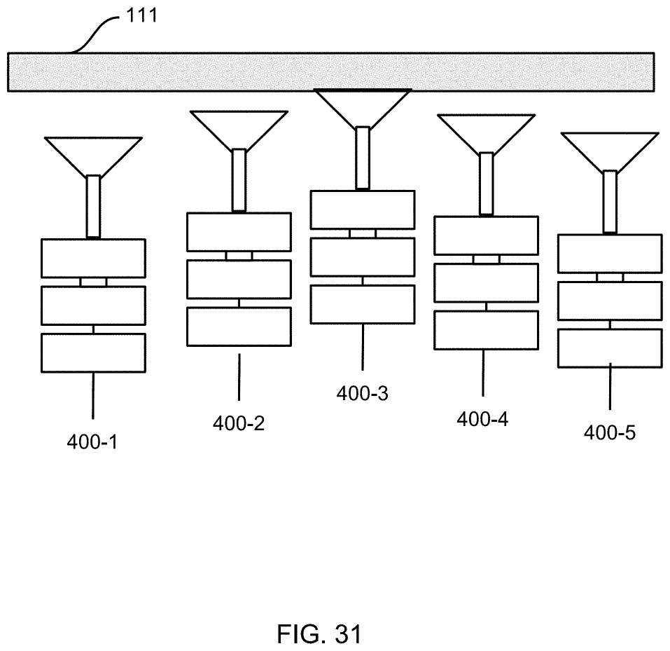

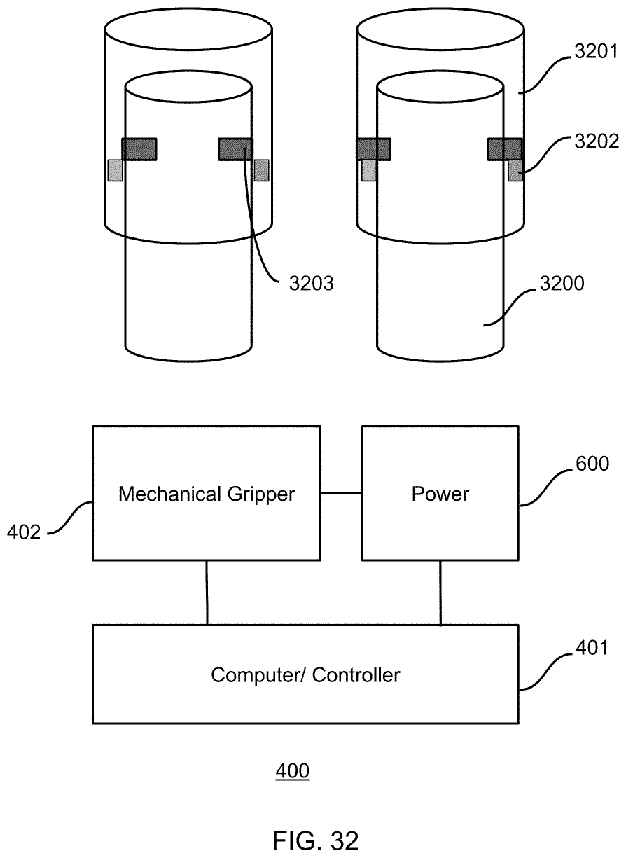

FIG. 31 shows a gripping mechanism such as vacuum suction mechanism in detail which involves three steps 1) preparation state, 2) sticking state, and 3) drop or separation state.

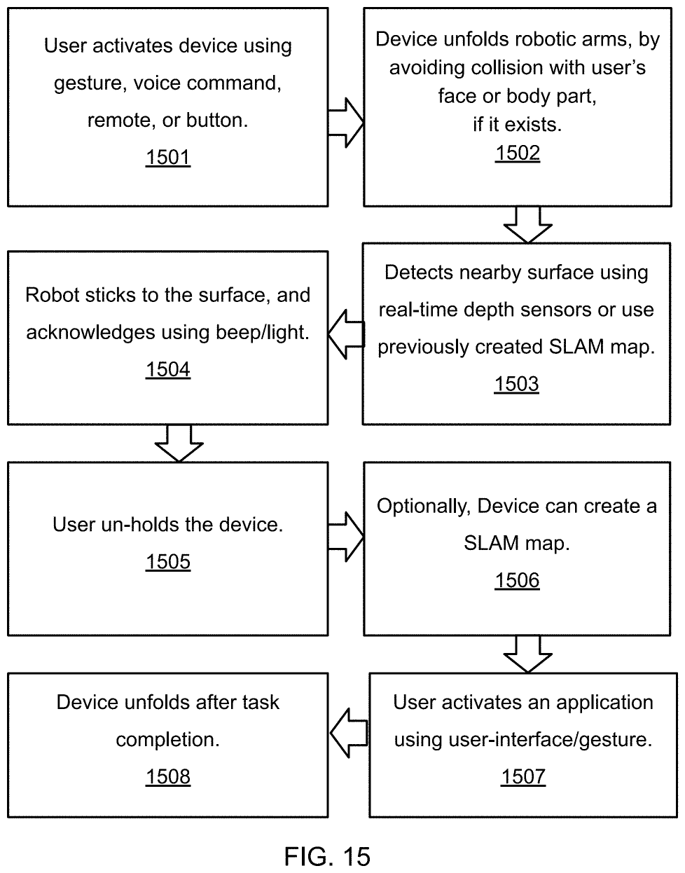

It may be used as a personal computer or mobile computing device whose interaction with humans is described in a flowchart in FIG. 15. In step 1501 the user activates the device. In step 1502 the device unfolds its robotic arm by avoiding collision with the user's face or body. In step 1503 of the algorithm, the device detects nearby surfaces using sensors. During step 1503, the device can use previously created maps using SLAM. In step 1504 the device sticks to the surface and acknowledges using a beep and light. In step 1505, the user releases the device. In step 1506, optionally, the device can create a SLAM. In step 1507 the user activates the application. Finally, after task completion, in step 1508, the user can unfold the device using a button or command.

All components are connected with a centralized computer. System may use an Internet connection. System may also work offline to support some applications such as watching a stored video/movie in the bathroom, but to ensure the user defined privacy and security, it will not enable a few applications or features such as GPS tracking, video chat, social-networking, search applications, etc.

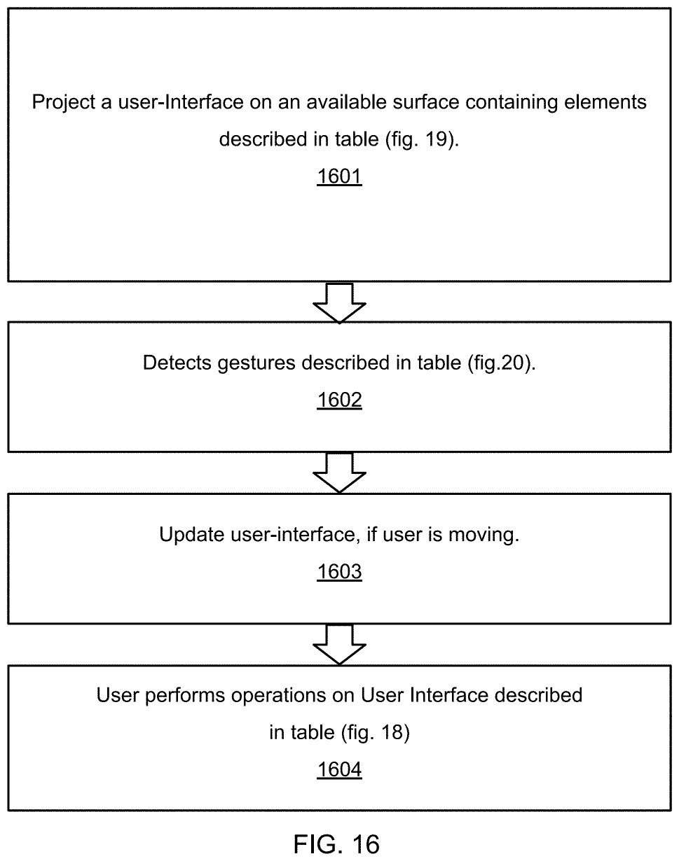

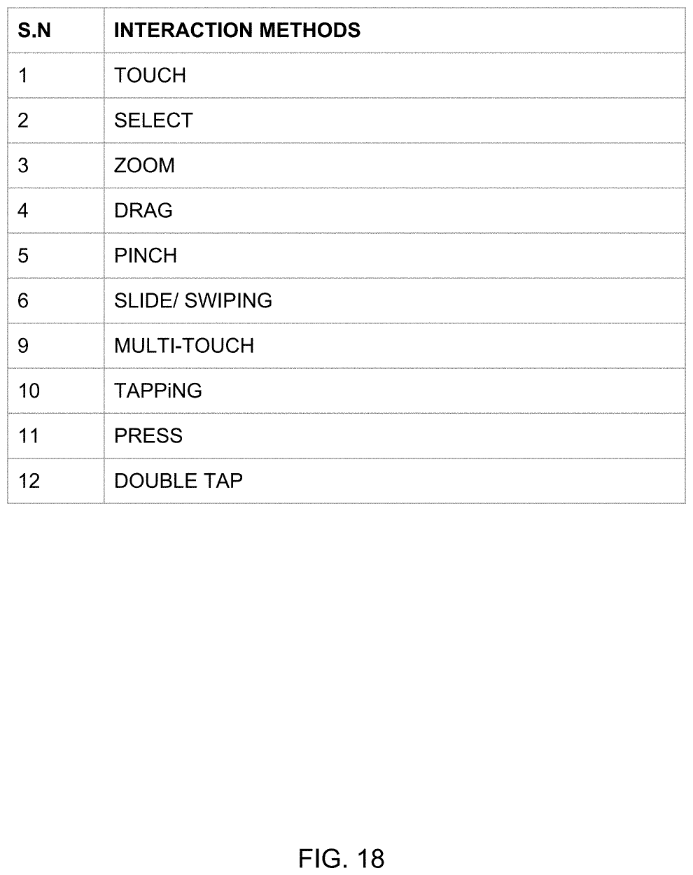

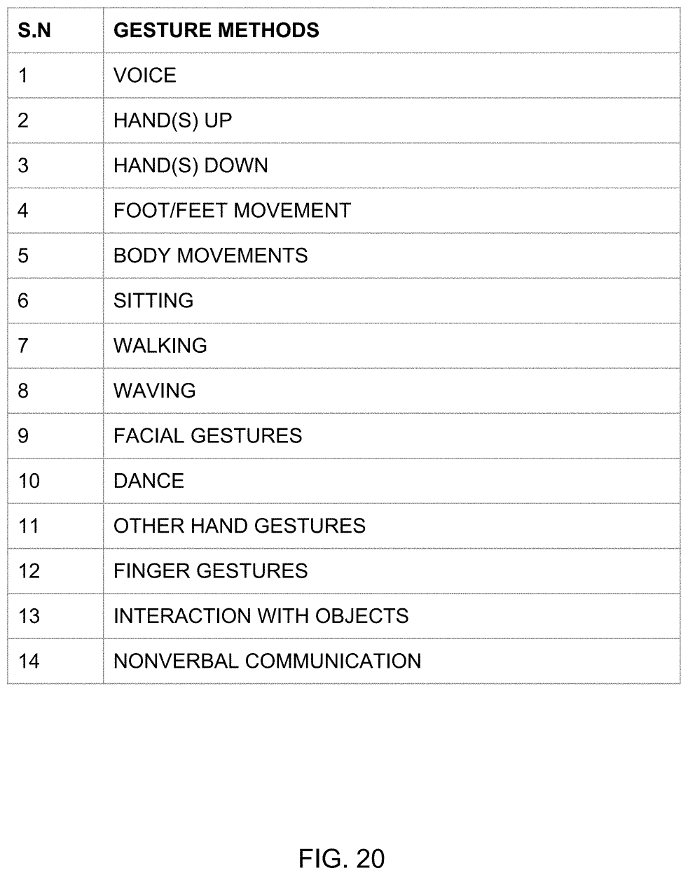

Flow chart given in FIG. 16 describes how users can interact with the user interface with touch, voice, or gesture. In step 1601, the user interface containing elements such as window, menu, button, slider, dialogs, etc., is projected on the surface or onboard display or on any remote display device. Some of the user interface elements are listed in table in FIG. 19. In step 1602, the device detects gestures such as hands up, body gesture, voice command, etc. Some of the gestures are listed in a table in FIG. 20. In step 1603, the device updates the user interface if the user is moving. In step 1604 the user performs actions or operations such as select, drag, etc. on the displayed or projected user interface. Some of the operations or interaction methods are listed in table in FIG. 18.

### Applications

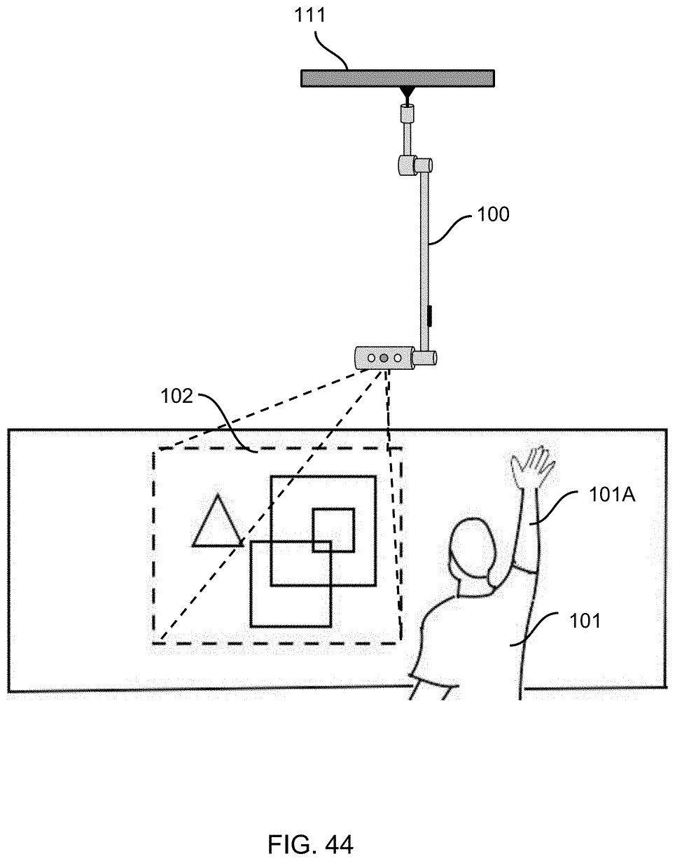

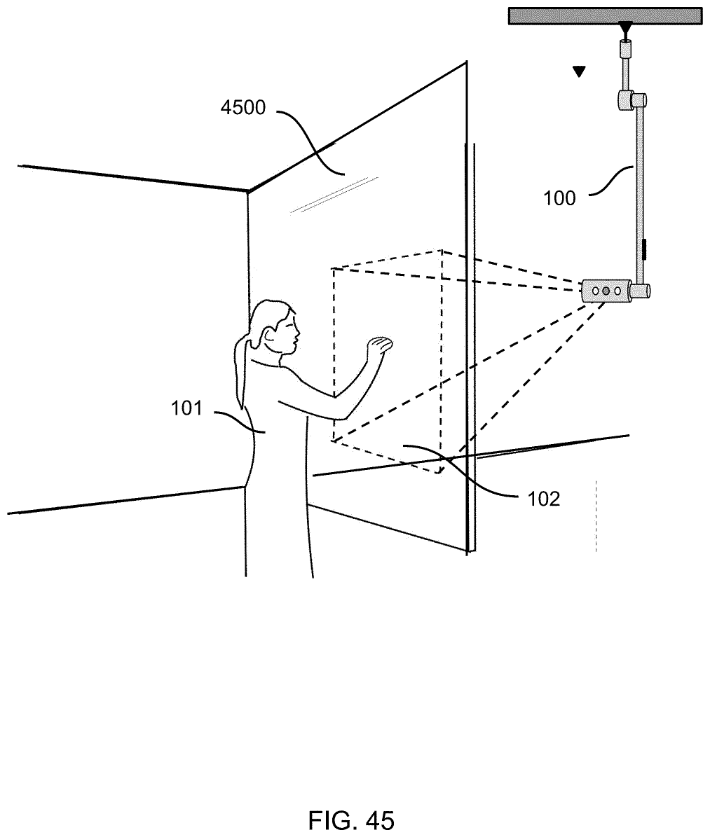

Application in FIG. 36 shows how the user can interact with the user interface projected by the device on the surface or wall. There are two main ways of setting projection. In the first way, Device can set projection from behind the user as shown in FIG. 44. In another style as shown in FIG. 45, the user interface can be projected from front of the user through a transparent surface like a glass wall. It may convert the wall surface into a virtual interactive computing surface.

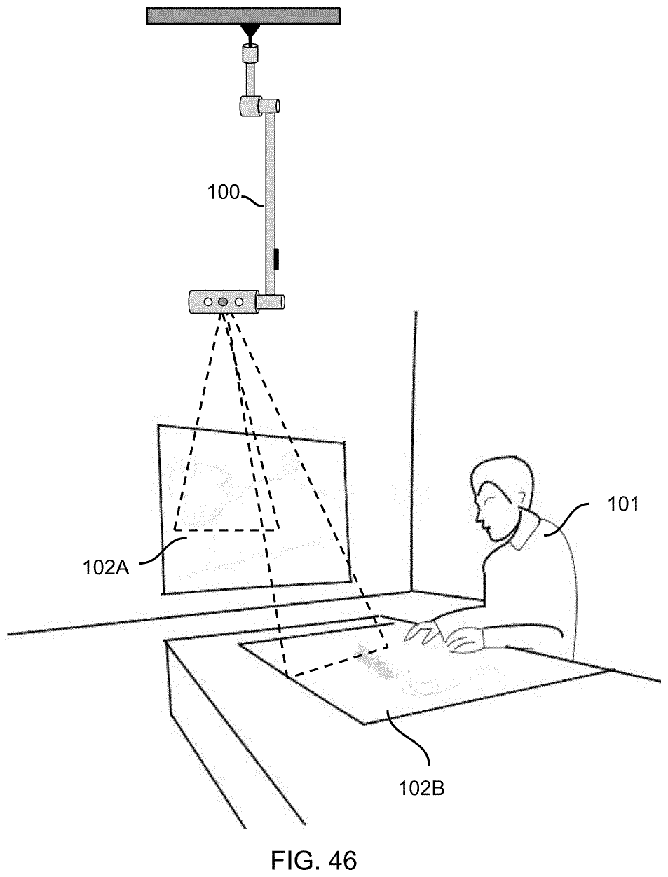

Application in FIG. 46 shows how the user 101 can device 100 to project user interface on multiple surfaces such as 102A on wall and 102B on table.

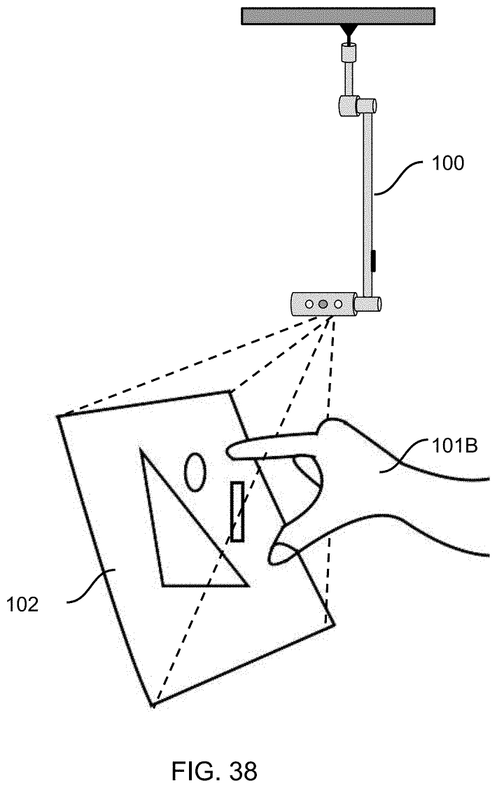

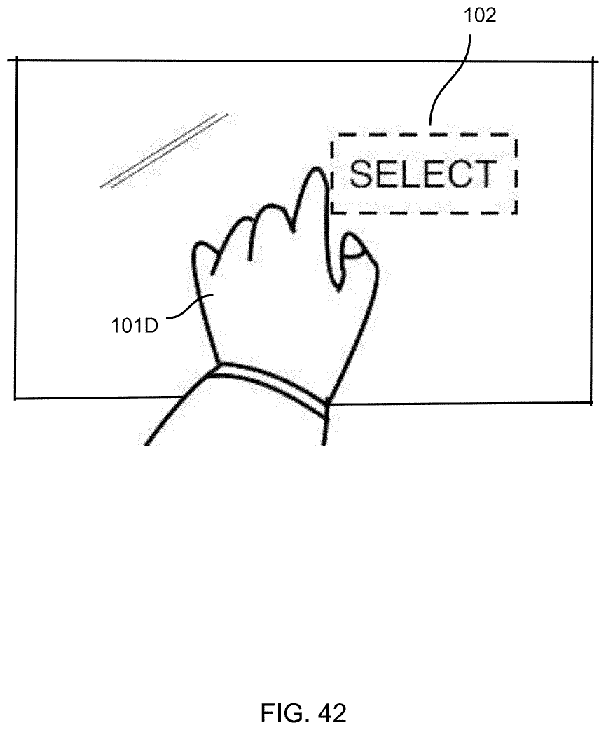

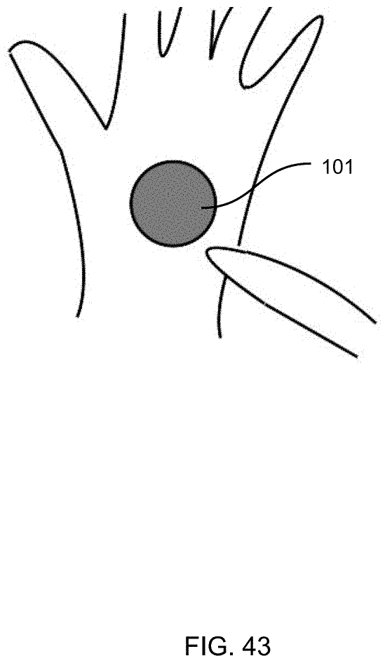

Applications in FIGS. 43 and 42 show how user is using finger as a pointing input device like a mouse pointer. Users can also use midair gestures using body parts such as fingers, hands, etc. Application in FIG. 38 shows how user 3100 is using two finger and multi-touch interaction to zoom projected interface 102 by device 100.

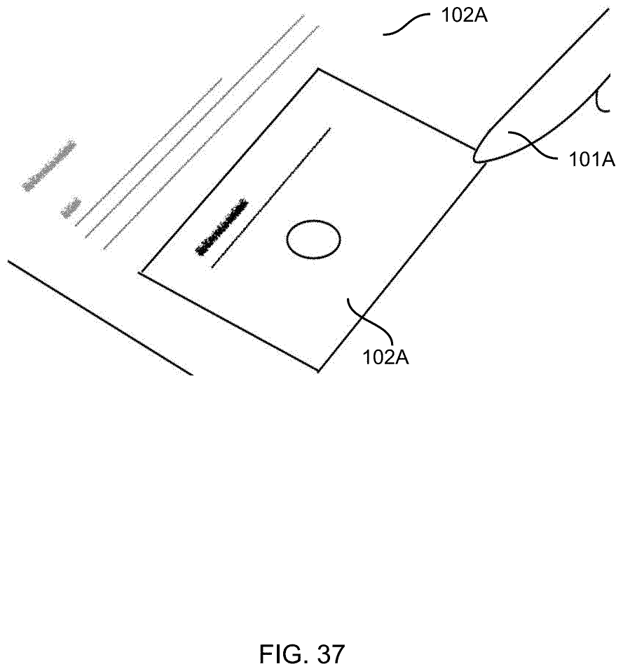

Application in FIG. 37 shows how the user can select an augmented object or information by creating a rectangular area 102A using finger 101A. Selected information 102A can be saved, modified, copied, pasted, printed or even emailed, or shared on social media.

Application in FIG. 42 shows how the user can select options by touch or press interaction using hand 101D on a projected surface 102. Application in FIG. 40 shows how the user can interact with augmented objects 102 using hand 101A. Application in FIG. 44 shows examples of gestures (hands up) 101A understood by the device using machine vision algorithms.

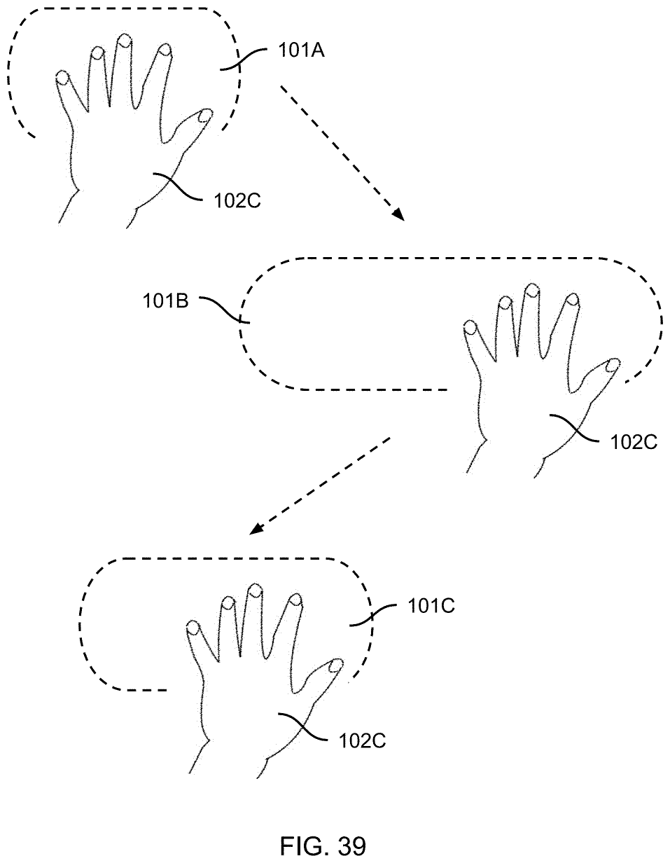

Application in FIG. 46 shows an example how user 101 can select and drag an augmented virtual object 102A from one place to another place 102B in the physical space using device 100. Application in FIG. 39 shows an example of drawing and erasing interaction on the walls or surface using hand gesture 102C on a projected user interface 102A, 102C, and 102C. Application in FIG. 36 shows an example of typing by user 101 with the help of projected user interface 102 and device 100. Application in FIG. 43 shows how a user can augment and interact his/her hand using projected interface 102.

The device can be used to display holographic projection on any surface. Because the device is equipped with sensors and camera, it can track the user's position, eye angle, and body to augment holographic projection.

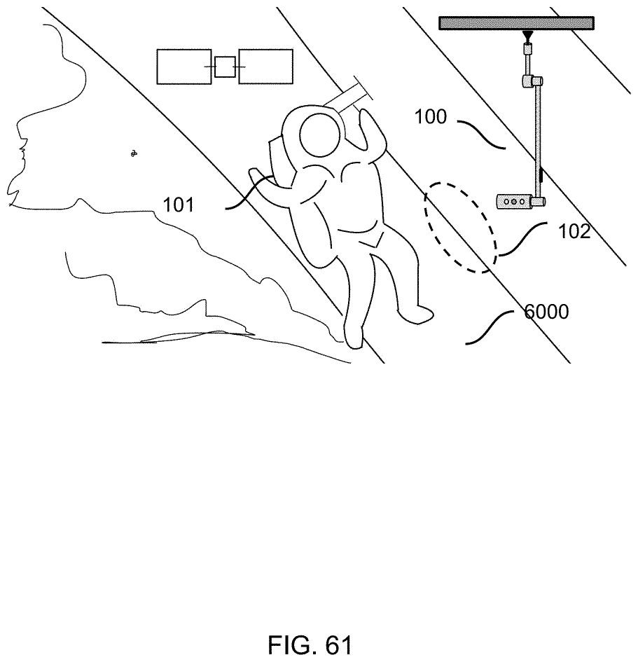

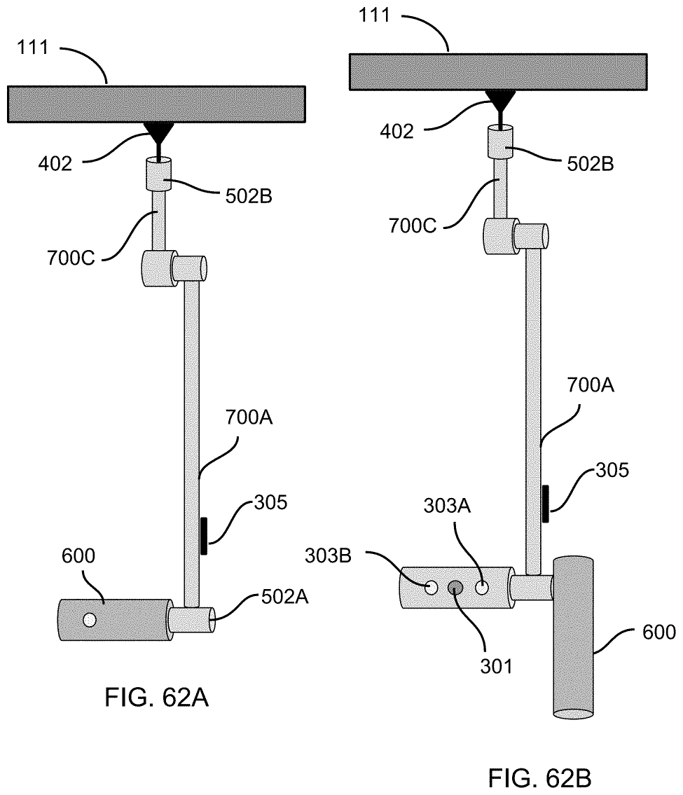

The device can be used to assist astronauts during the space walk. Because of zero gravity, there is no ceiling or floor in the space. In this application, the device can be used as a computer or user interface during the limited mobility situation inside or outside the spaceship or space station as shown in FIG. 61.

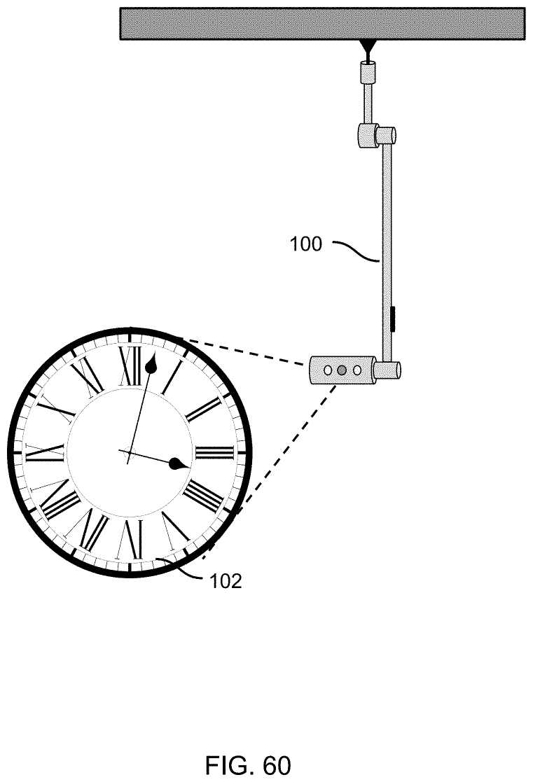

The device can stick to an umbrella from the top, and projects user interface using a projector-camera system. In this case the device can be used to show information such as weather, email in augmented reality. The device can be used to augment a virtual wall on the wall as shown in FIG. 60.

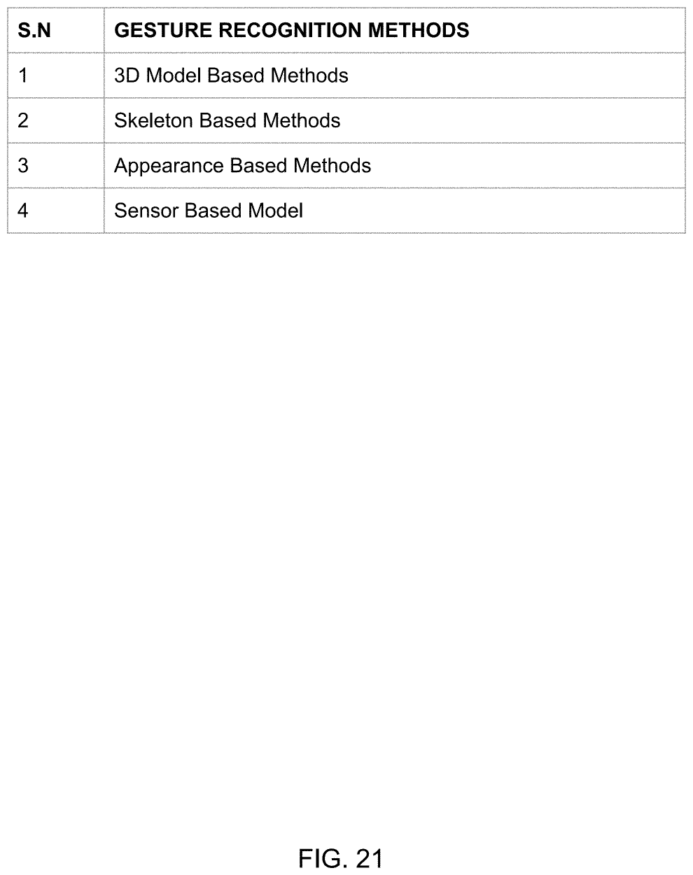

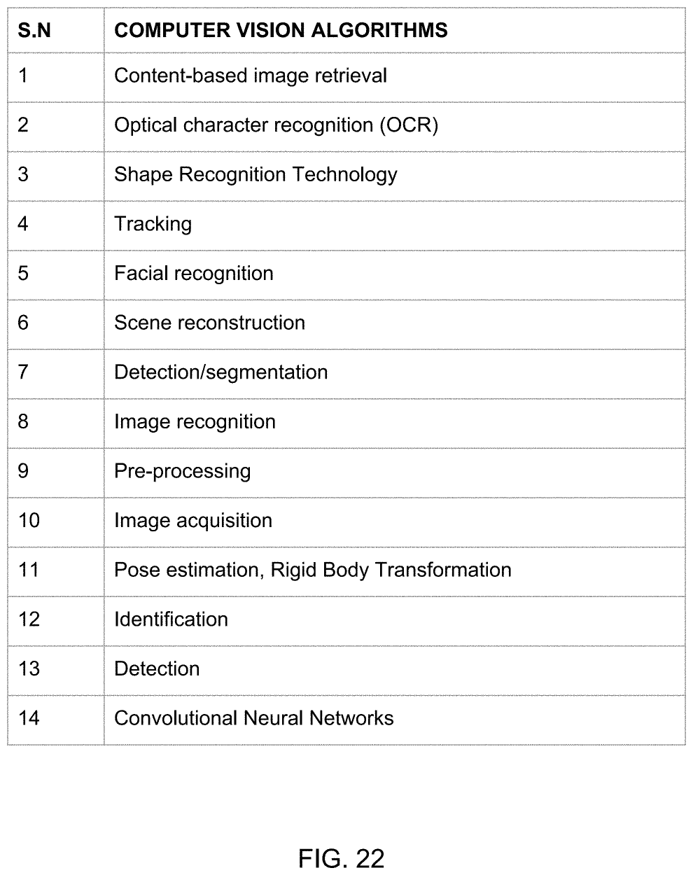

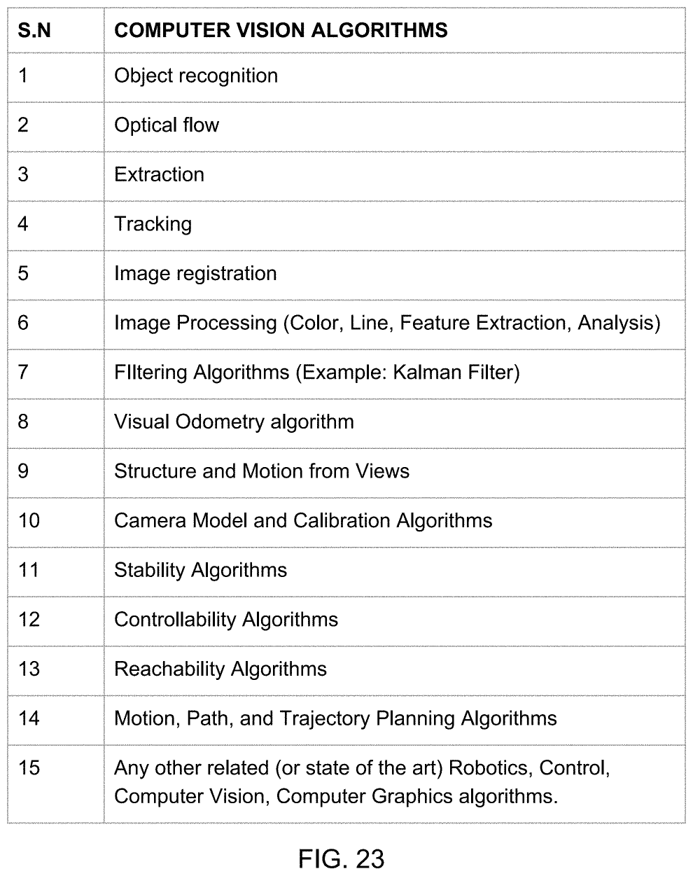

The device can recognize gestures listed in FIG. 21. The device can use available state of the art computer vision algorithms listed in tables in FIGS. 22 and 23. Some of the examples of human interactions with the device are: Users can interact with the devices using handheld devices such as Kinect or any similar devices such as smartphones consisting of a user interface. Users can also interact with the device using wearable devices, head mounted augmented reality or virtual reality devices, onboard buttons and switches, onboard touch screen, robotic projector camera, any other means such as Application Programming Interface (API) listed in FIG. 17. Application in FIG. 44 shows examples of gestures such as hands up and human-computer interaction understood by the device using machine vision algorithms. These algorithms first build a trained gesture database, and then they match the user's gesture by computing similarity between input gesture and pre-stored gestures. These can be implemented by building a classifier using standard machine learning techniques such as CNN, Deep Learning, etc. various tools can be used to detect natural interaction such as OpenNI (https://structure.io/openni), etc.

Users can also interact with the device using any other (or hybrid interface of) interfaces such as brain-computer interface, haptic interface, augmented reality, virtual reality, etc.

The device may use its sensors such as cameras to build a map of the environment or building 3300 using Simultaneous Localization and Mapping (SLAM) technology. After completion of the mapping procedure, it can navigate or recognize nearby surfaces, objects, faces, etc. without additional processing and navigational efforts.

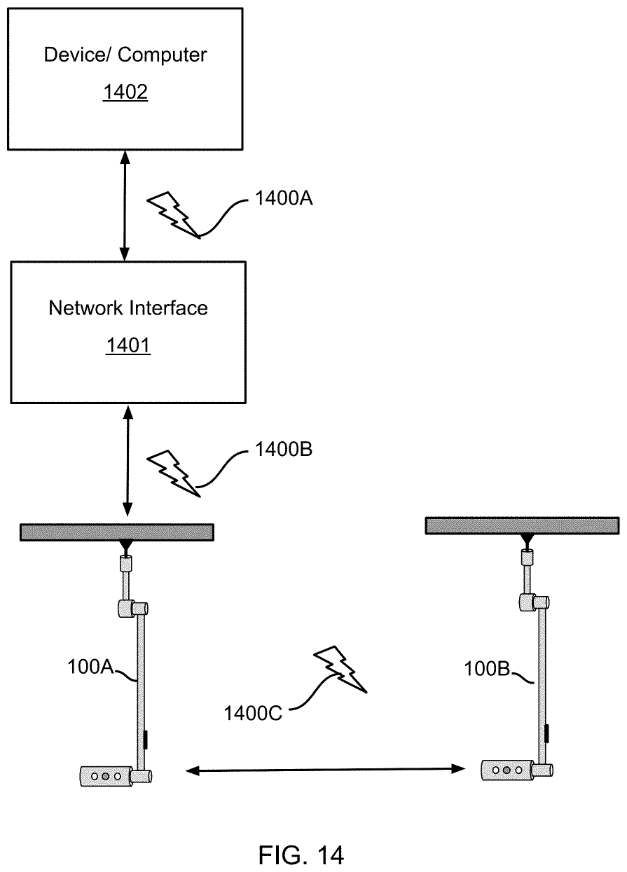

The device may work with another or similar device(s) to perform some complex tasks. For example, in FIG. 14, device 100A is communicating with another similar device 100B using a wireless network link 1400C.

The device may link, communicate, and command to other devices of different types. For example, it may connect to the TV or microwave, electronics to augment device specific information. For example, in FIG. 14 device 100A is connecting with another device 1402 via network interface 1401 using wireless link 1400B. Network interface 1401 may have wireless or wired connectivity to the device 1401. Here are the examples of some applications of this utility:

For example, multiple devices can be deployed in an environment such as a building, park, jungle, etc. to collect data using sensors. Devices can stick to any suitable surfaces and communicate with other devices for navigation, planning for distributed algorithms.

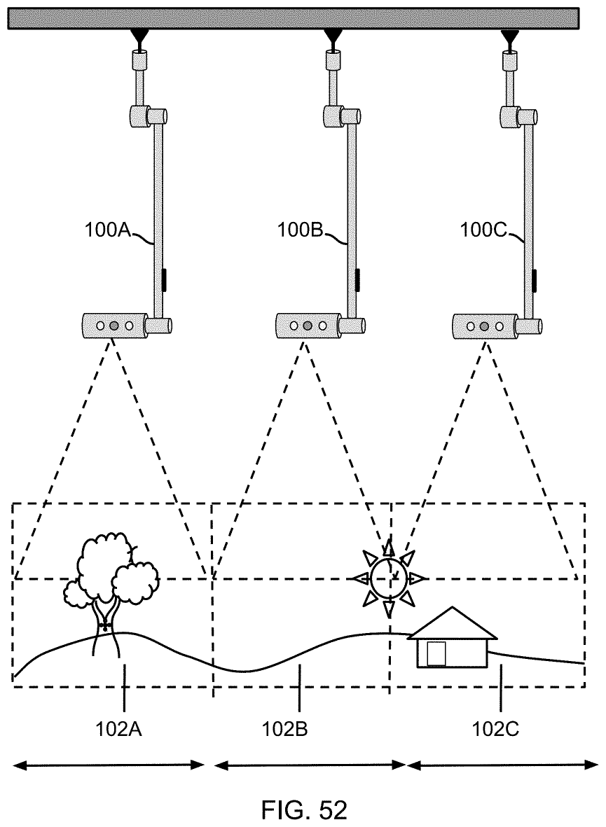

Application in FIG. 52 shows a multi-device application where multiple devices are stuck to the surface such as a wall, and create a combined large display by stitching their individual projections. Image stitching can be done using state of the art or any standard computer vision algorithms such as feature extraction, image registration (ICP), correspondence estimation, RANSAC, homography estimation, image warping, etc.

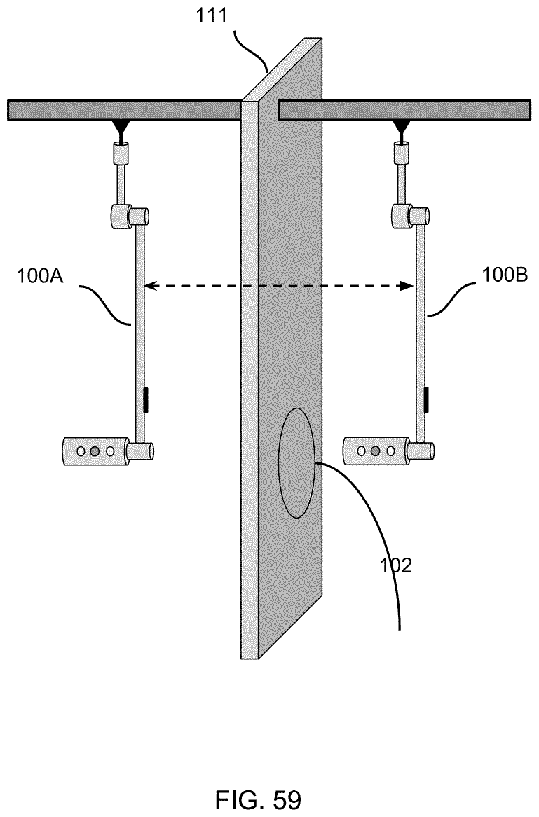

Two devices can be used to simulate a virtual window, where one device can capture video from outside of the wall, and another device can be used to render video using a projector camera system on the wall inside the room as shown in FIG. 59.

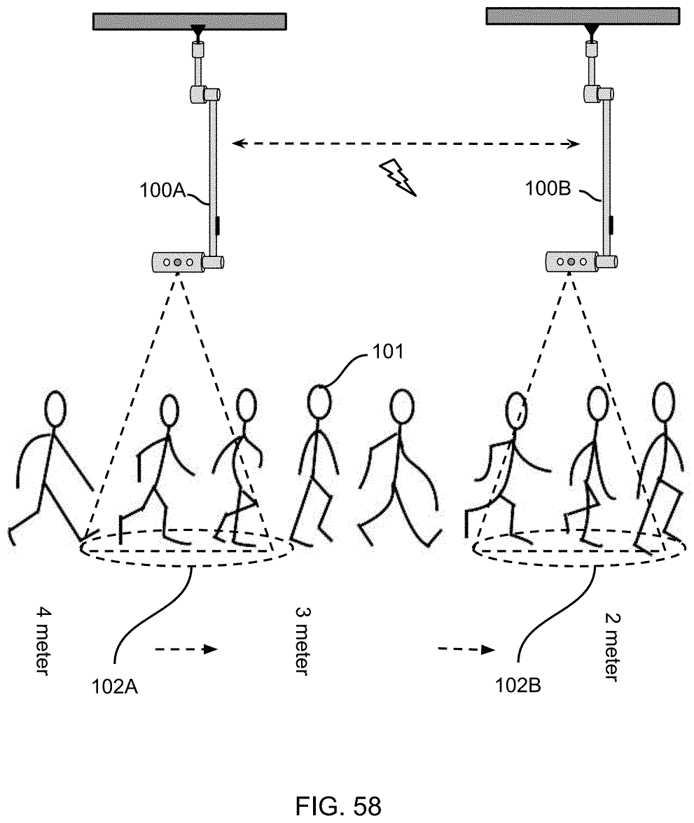

Application in FIG. 58 shows another such application where multiple devices 100 can be used to assist a user using audio or projected augmented reality based navigational user interface 102. It may be a useful tool while walking on the road or exploring inside a library, room, shopping mall, museums, etc.

The device can link with other multimedia computing devices such as Apple TV, Computer, and project movie and images on any surface using a projector-camera equipped robotic arm. It can even print projected images by linking to the printer using gestures.

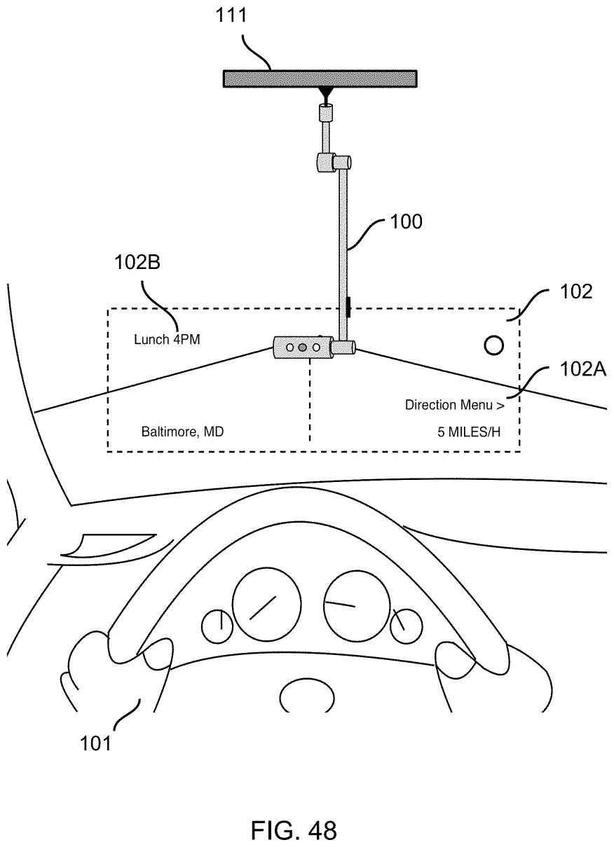

Device can directly link to the car's computer to play audio and other devices. If the device is equipped with a projector-camera pair, it can also provide navigation on augmented user interface as shown in FIG. 48.

In another embodiment, the device can be used to execute application specific tasks using a robotic arm equipped with reconfigurable tools. Because of its mobility, computing power, sticking, and application specific task subsystem, it can support various types of applications varying from simple applications to complex applications. The device can contain, dock, or connect other devices, tools, sensors, and execute application specific task.

### Multi-Device and Other Applications

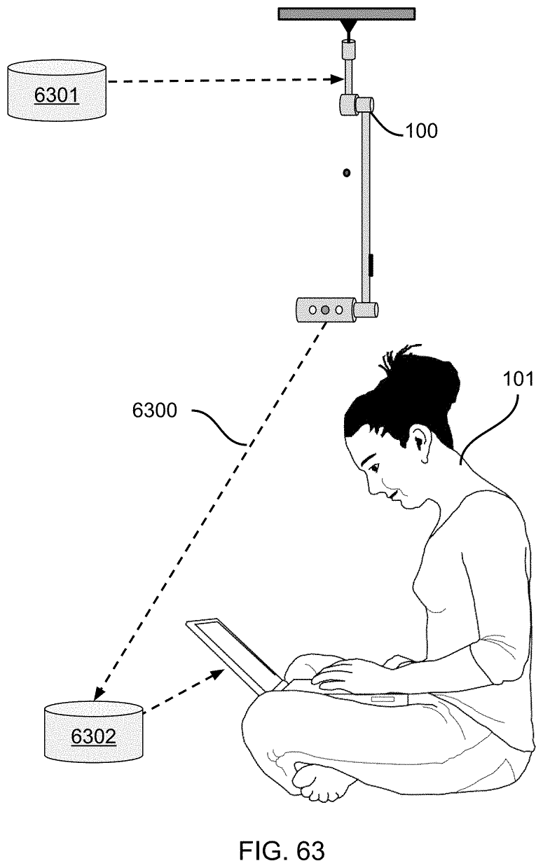

Multiple devices can be deployed to pass energy, light, signal, and data to any other devices. For example, devices can charge laptops at any location in the house using LASER or other types of inductive charging techniques as shown in FIG. 63. For example, devices can be deployed to stick various place in the room and pass light/signal 6300 containing internet and communication data from source 6301 to other device(s) and receiver(s) 6302 (including multiple intermediate devices) using wireless, Wi-Fi, power, or Li-Fi. technology.

The device can be used to build sculpture using predefined shape using on board tools equipped on a robotic arm. The device can be attached to material or stone, and can carve, print surfaces using onboard tools. For example, FIG. 65 shows how a device can be used to print text and image on a wall.

The device can also print 3D objects on any surface using onboard 3D printer devices and equipment. This application is very useful to repair some complex remote system, for example a machine attached to any surface or wall or satellite in space.

Devices can be deployed to collect earthquake sensor data directly from the Rocky Mountains and cliffs. Sensor data can be browsed by computers and mobile interfaces, even can directly feed to the search engines. This is a very useful approach where Internet users can find places using sensor data. For example, you can search weather in a given city with a real-time view from multiple locations such as a lakeside, directly coming from a device attached to a nearby tree along the lake. Users can find dining places using sensor data such as smell, etc. Search engines can provide noise and traffic data. Sensor data can be combined, analyzed, and stitched (in case of images) to provide a better visualization or view.

The device can hold other objects such as letterboxes, etc. Multiple devices may be deployed as speakers in a large hall. The device can be configured to carry and operate as internet routing device. Multiple devices can be used to provide Internet access at remote areas. In this approach, we can extend the Internet to remote places such as jungles, villages, caves, etc. Devices can also communicate with other routing devices such as satellites, balloons, planes, ground based Internet systems or routers. The device can be used to clean windows at remote locations on windows. The device can be used as giant a supercomputer (clusters of computers) where multiple devices are stuck to the surfaces in the building. Advantage of this approach is to save floor space, and use ceiling for computation. The device can also find appropriate routing path and optimized network connectivity. Multiple devices can be deployed to stick in the environment, and can be used to create image or video stitching autonomously in real-time. The users can also view live 3D in a head mounted camera. Device(s) can move a camera equipped on a robotic arm with respect to the user's position and motion.

In addition, users can perform these operations from remote places (tele-operation) using another computer device or interface such as smart phone, computer, virtual reality, or haptic device. The device can stick on the surface under the table and manipulate objects on top of the table by physical forces such magnetic, electrostatic, light, etc. using on board tools or hardware. The device can visualize remote or hidden parts of any object, hill, building, or structure by collecting camera images from hidden regions to the user's phone or display. This approach creates augmented reality-based experiences where the user can see through the object or obstacle. Multiple devices can be used to make a large panoramic view or image. The device can also work with other robot which do not have the capability of sticking to perform some complex tasks.

Because the device can stick to nearby tree branches, structures, and landscapes, it can be used for precision farming, survey of bridges, inspections, sensing, and repairing of complex machines or structures.

1. A computing device comprising robotic arm system to reach nearby surface, user interface system to provide human interaction and gripping system to stick to nearby surface using a sticking mechanism.

2. The User interface recited in the claim 1 can process input data from cameras, sensors, button, microphone, etc. and provide output to a projectors, speakers, or external display to execute human-computer interaction.

3. In addition to the three basic components cited in claim 1, the device may have an application sub-system containing application specific devices, sensors to execute application tasks.

4. Quality, quantity, and size of any components described in claim 1, may vary and may depend on the nature of the application or task and may have ability to configure tools; for example: devices arm with three degrees of freedom instead of two degrees of freedom; Arms may have different length and size; Device may have only one suction system attached to a central gripping system; Device may have multiple gripping systems of different type and shape; Device may have two projectors, five cameras, and multiple computing device or computer; Device may use any other type of state of the art projection system or technology such as Laser or Holographic Projector.

5. Tools, Sensor, and Application specific device can attach to robotic arm, application system or directly to the on-board computer.

6. The user can use a pointing device such as mouse, pointer pen, etc. to interact with user-interface projected by the device as recited in the claim 1.

7. The user can use body to interact with user-interface projected by the device as recited in the claim 1 for example: Hand gesture as pointer or input device; Feet gesture as pointing or input device; Face gesture as pointing or input device; Finger gesture as pointing or input device; Voice commands.

8. Multiple users can interact with user-interface using gestures and voice command to a single device as recited in the clam 1 to support various computer-supported cooperative work such as devices that can be used to teach English to kids at the school.

9. The device recited in the claim 1, can dynamically change pose or orientation of robotic arms.

10. The device recited in the claim 1, can stick, connect or dock to power source, other devices, or similar devices for the purpose of recharge and data communication.

11. The device recited in the claim 1, can also find and identify the owner user.

12. The device recited in the claim 1, can link, communicate, and synchronize to other devices of same design and type described in this patent to accomplish various complex applications such as large display wall and Virtual window.

13. The device recited in the claim 1, can link to other devices of different type for example: It may connect to the TV or microwave; It may connect to the car's electronics to augment device specific information such as speed via speedometer, songs list via audio system on the front window or windshield; It may connect to the printer to print documents, images that are augmented on the projected surface.

14. The device recited in the claim 1, has the ability to make a map of the environment using computer vision techniques such as Simultaneous Localization and Mapping (SLAM).

15. The device also supports Application Programming Interface (API) and software development kit for other researchers, and engineers to design new applications for the device system or device as recited in the clam 1. Users can also download and install free or paid applications or apps for various tasks.

16. The device recited in the claim 1, may use a single integrated chip containing all electronic or computer subsystems and components; for example, electronic speed controllers, flight control, radio, computers, gyroscope, accelerometer, etc. can be integrated on a single chip.

17. The device recited in the claim 1, may have centralized or distributed system software such as Operating Systems, Drivers; for example, the computer may have flight control software or flight controller may have its own software communicating as a slave to the main computer.

18. The device recited in the claim 1, may use sensors to detect free fall during the failed sticking mechanism and autonomously fold or cover important components such as battery, etc. to the avoid damage; for example, device can use accelerometer, gyroscope, barometer, laser sensor to detect free fall using a software system.

19. The device recited in the claim 1, may use user gestures, inputs, and sensors reading for a stable and sustainable control or navigation using various AI, computer vision, machine learning, and robotics control algorithms such as PD, PID, Cascade control, De-couple control algorithms, Kalman Filter, EKF, Visual Odometry, Probabilistic state estimation Algorithms, etc.

20. The device recited in the claim 1, may have multiple gripping systems for various surfaces, and ability to switch and deploy them autonomously based on the nature of the surface.
